(19) United States
(12) Patent Application Publication
(10) Pub. No.: US 2016/0034980 A1
(43) Pub. Date: Feb. 4, 2016

(54) METHOD AND SYSTEM TO EVALUATE THE CONDITION OF CLIENT EQUIPMENT AND ACCURATELY ASSESS THE PRICE AND EXTENT OF REPAIRS

(71) Applicant: iCracked Inc., Redwood City, CA (US)

(72) Inventors: David Petrie, Wellington (NZ); Martin AMPS, Redwood City, CA (US); Adam Forsythe, Redwood City, CA (US); Jonathan FRIEDMAN, Redwood City, CA (US); Paul ILIYA, Redwood City, CA (US); Anthony MARTIN, Redwood City, CA (US)

(21) Appl. No.: 14/814,478

(22) Filed: Jul. 30, 2015

Related U.S. Application Data
(60) Provisional application No. 62/031,501, filed on Jul. 31, 2014.

(51) Int. Cl. G06Q 30/02

(52) U.S. Cl. CPC G06Q 30/0278

(57) ABSTRACT

Method and system for evaluating the condition of client equipment and accurately assess the price and extend of repairs. The method includes extracting necessary information from a client device and subsequently evaluating the information automatically. Further, the method includes categorizing the client device based on the extracted information. Furthermore, the method includes evaluating the price of the client device buy back condition based on the categorization. Moreover, the method includes assessing current condition of the client device and predicting the best buy back price for the client device in response to the assessment.

### TECHNICAL FIELD

Embodiments of the disclosure relate generally to the field of mobile devices. Embodiments relate more particularly to evaluating the price value of mobile devices by determining its present state and condition.

### BACKGROUND

Rapid technology change, low initial cost and planned obsolescence have resulted in a fast-growing surplus which contributes to the increasing amount of electronic waste around the globe. Recyclers consider electronic waste a rapidly expanding issue and in countries like the United States, an estimated 70% of heavy metals in landfills come from discarded electronic items.

Americans throw away millions of cell phones each year in favor of new technology—and all the discarded phones take a toll on the environment. Electronic scrap accounts for 70 percent of the overall toxic waste currently found in landfills. According to the U.S Environmental Protection Agency (EPA), 141 million mobile phones were discarded in 2009 and only 12 million of those were collected for recycling. A cell's phone life is only about 24 months for the average tech savvy consumer which means that newer cell phone models are constantly put up on the market to replace older ones. This is a result of the rapid progression of technology in the mobile industry which means that newer cell phones are continually on the rise of consumerism and thus more outdated models are likely to end up in landfills.

Electronic waste (e-waste) is a global problem, especially since many developed countries including the U.S ship their discarded electronic devices to less developed parts of the world. Often, the e-waste is improperly dismantled and burned, producing toxic emissions harmful to waste site workers, children and nearby communities. Therefore, it is important for cell phone users to dispose of and recycle their devices responsibly and ethically.

One effective means of doing so is called “buy back” in which the owner sells the used phone to a recycler. Currently, several organizations guarantee to recycle the phones in an environmentally sound way or offer the best buy back prices to the consumer based on the phone's current condition. However, these organizations do not have local collection or repair points, cannot service multiple devices simultaneously, offer no wireless connectivity. Also, these organizations are not able to effectively determine the amount of damage or wear and tear caused to the phone and so accordingly is not able to classify it under an accurate category to predict the best price.

In the light of the above discussion, there appears to be a need for a portable system which allows plugging in any type of mobile device and correspondingly reading all the necessary information on the device including parameters such as diagnostics, serial number, and hardware information and so on, thus streamlining the entire buy back business procedure.

### SUMMARY

The above-mentioned needs are met by a method and system to evaluate the condition of client equipment and accurately assess the price and extend of repairs.

An example of a method for evaluating the condition of client equipment and accurately assessing the price and extend of repairs includes extracting necessary information from a client device and subsequently evaluating the information automatically. Further, the method includes categorizing the client device based on the extracted information. Furthermore, the method includes evaluating the price of the client device buy back condition based on the categorization. Moreover, the method includes assessing current condition of the client device and predicting the best buy back price for the client device in response to the assessment.

An example of a system for evaluating the condition of client equipment and accurately assessing the price and extend of repairs includes a client device that is a used computing device, a network and a processor coupled within the client device and configured to perform extracting necessary information from a client device and subsequently evaluating the information automatically, categorizing the client device based on the extracted information, evaluating the price of the client device buy back condition based on the categorization, assessing current condition of the client device and predicting the best buy back price for the client device in response to the assessment.

These and other aspect of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of the full handheld computer/host system, according to the embodiments as disclosed herein;

FIG. 2 is a PC board layout diagram illustrating a detailed schematic of the PC Board, according to the embodiments as disclosed herein;

FIG. 3 is a perspective illustration depicting the finished enclosure of a computing device, according to the embodiments as disclosed herein;

FIG. 4 is a block diagram depicting the categories of a used computing device to evaluate the price of a device buy back condition, according to the embodiments as disclosed herein;

FIGS. 5a and 5b, 5c and 5d, 5e and 5f, are graphical user interface images depicting the various stages of find my computing activation guide, in case the device is lost or stolen, according to the embodiments as disclosed herein;

FIG. 6 to FIG. 30 are various schematic illustrations of user interface displays depicting the entire operation cycle of the buyback/repair cycle process, according to the embodiments as disclosed herein; and

FIG. 31 is a block diagram of a machine in the example form of a computer system 3100 within which instructions for causing the machine to perform any one or more of the methodologies discussed herein may be executed.

### DETAILED DESCRIPTION OF THE EMBODIMENTS

The above-mentioned needs are met by a method and system for enabling a mobile device intelligence and interaction project to determine the quality and condition of a computing device. The following detailed description is intended to provide example implementations to one of ordinary skill in the art, and is not intended to limit the invention to the explicit disclosure, as one or ordinary skill in the art will understand that variations can be substituted that are within the scope of the invention as described.

The embodiments of the present invention propose a clear need for streamlining the entire buy back procedure. The embodiments herein comprise a system of hardware, software and networked devices that enable efficient improvements in the buy back process by allowing any type of mobile device to be connected to the system, where all the necessary information on the device, such as diagnostics, serial number, hardware information and so on may be read and evaluated automatically. Further, the embodiments herein comprise a system of hardware, software and networked devices that are also configured for BlueOcean devices. The information can be used to accurately categorize the device, assess its condition, predict the best buy back price and enable further process optimizations.

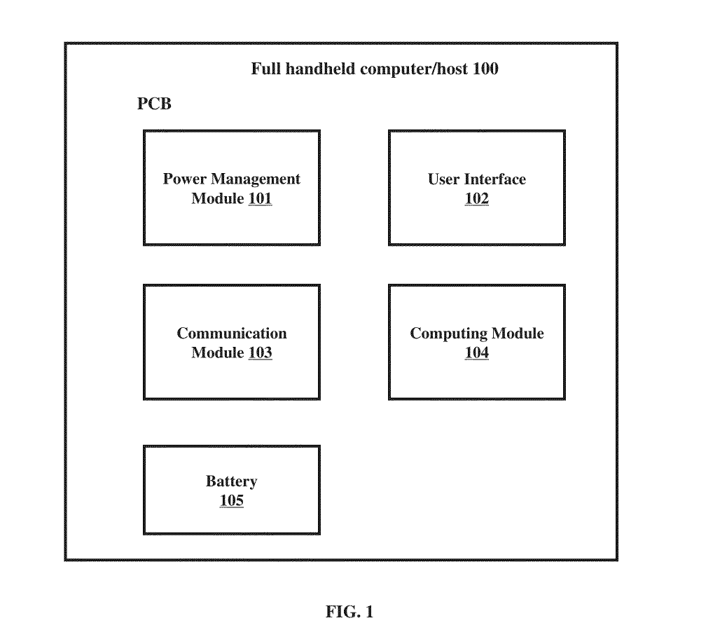

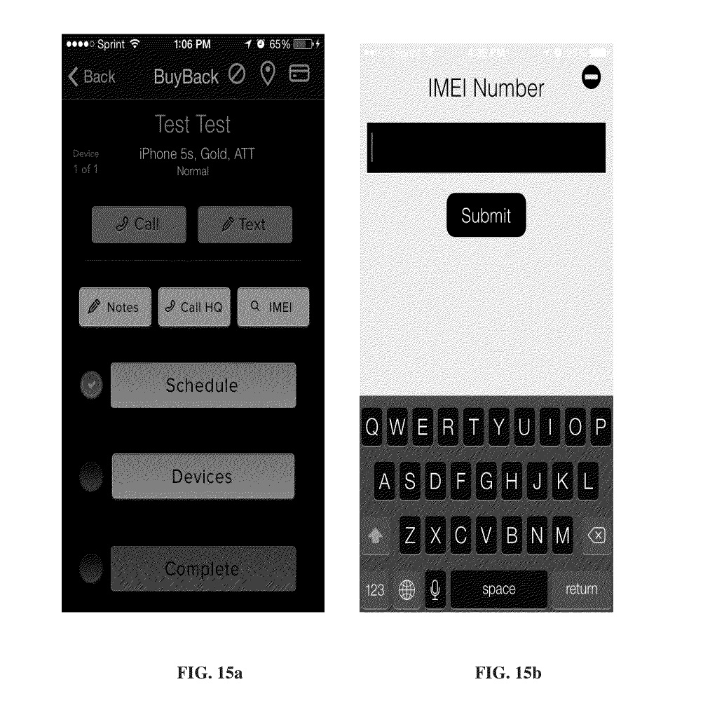

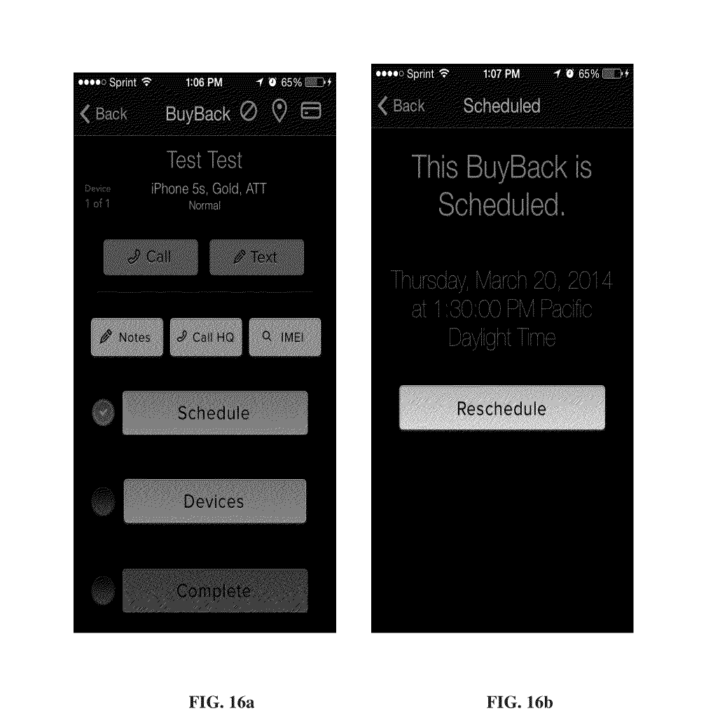

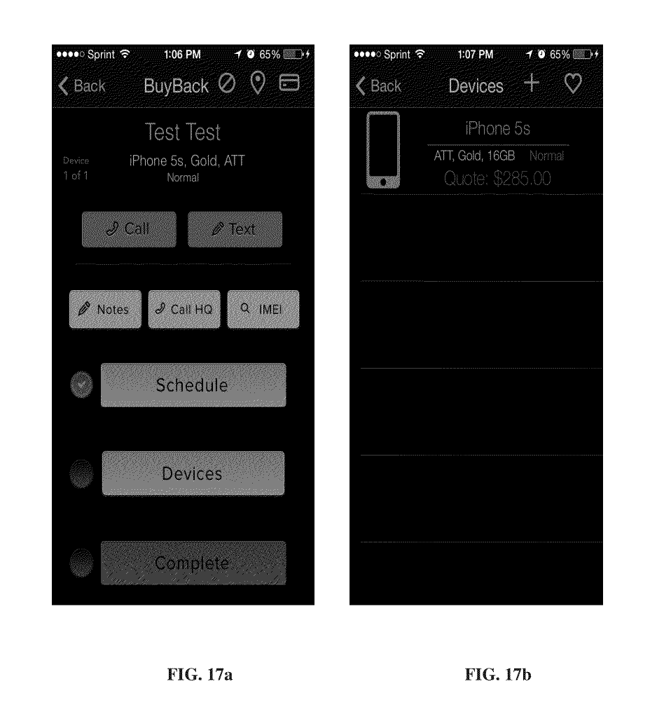

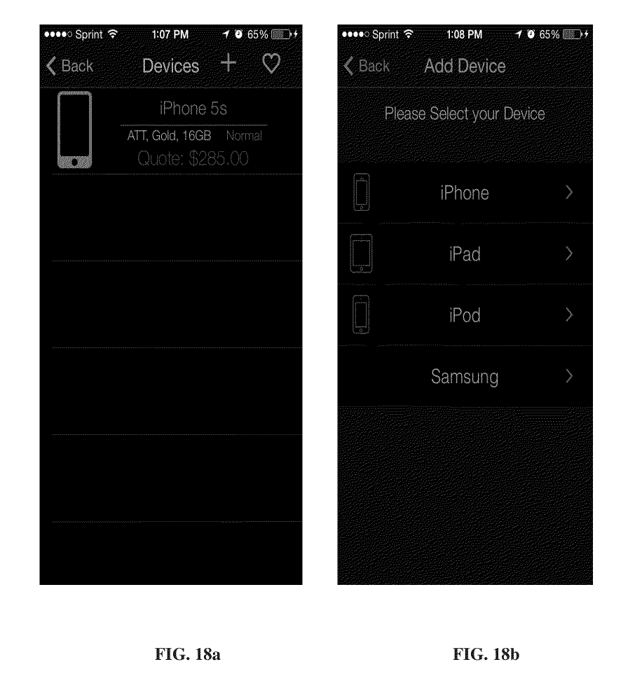

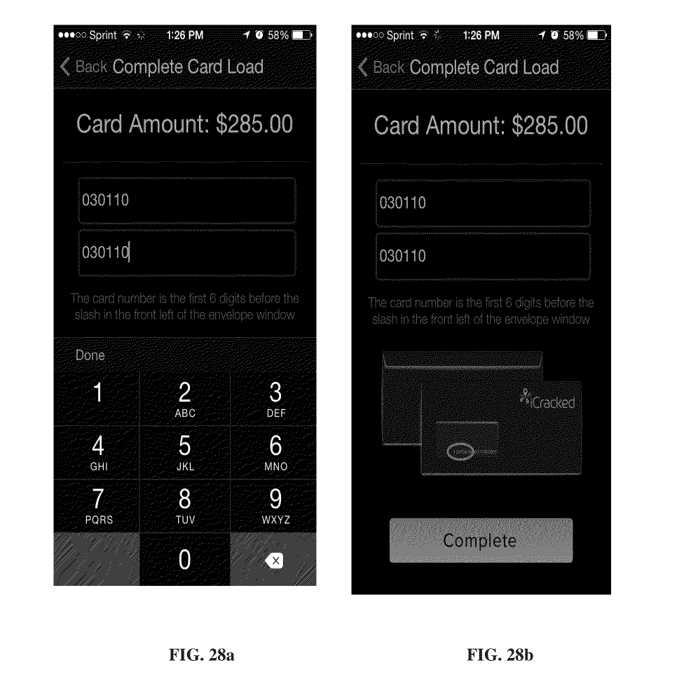

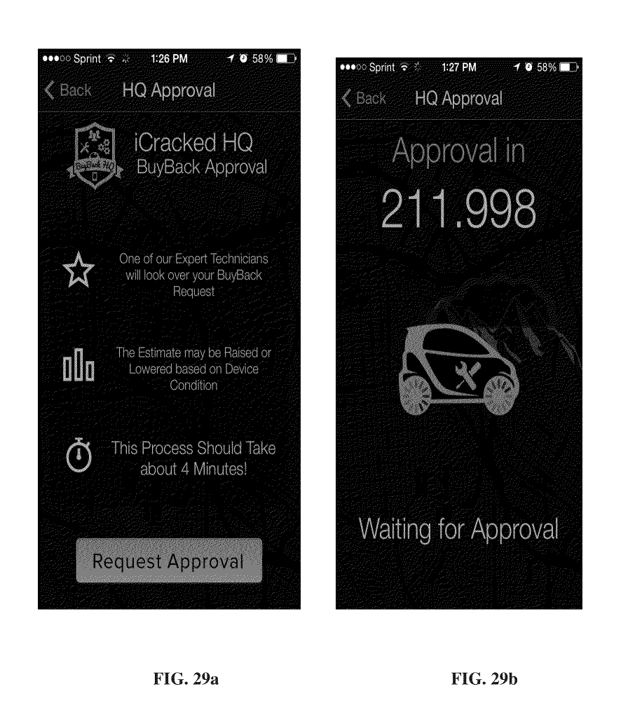

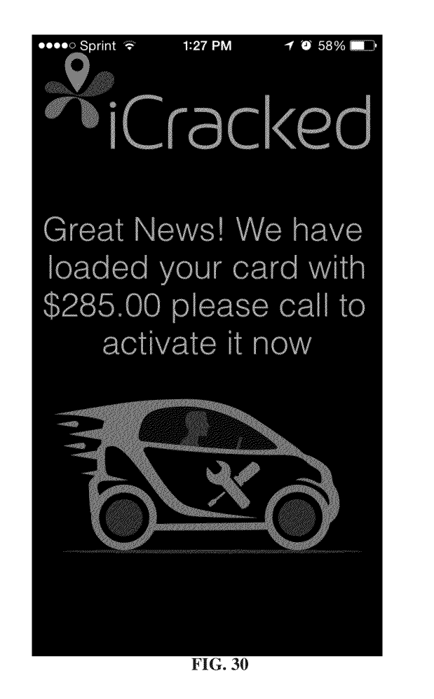

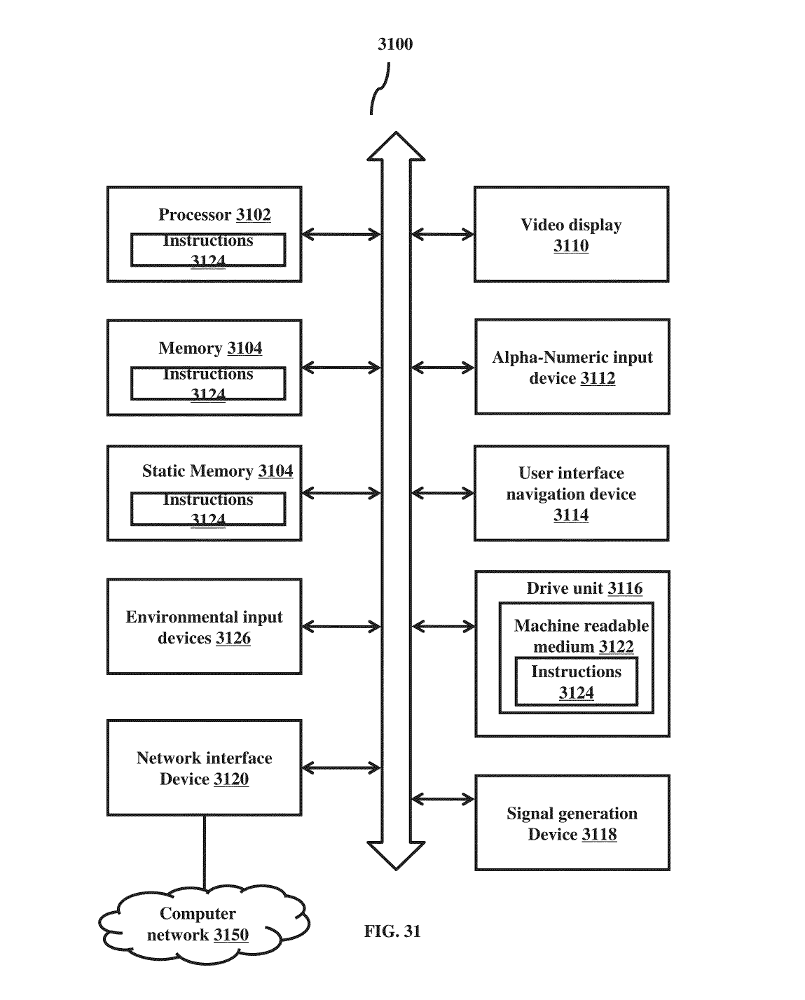

In the discussion which follows, various aspects of hardware implementations will be described, under the subheading “HARDWARE AND SYSTEM RELATED DESCRIPTION” and in connection with FIGS. 1, 2, and 3. System hardware implementations will be discussed further, under the subheading “EXEMPLARY SYSTEM ARCHITECTURE” and in connection with FIG. 31. Afterward, various aspects of software and graphical user interface embodiments will be discussed under the subheadings “PROCESS DESCRIPTION OF THE CURRENT METHOD TO EVALUATE THE CONDITION OF THE HARDWARE ELEMENTS AND IN TURN DETERMINING THE BUY BACK PRICE OF THE PHONE,” “CLASSIFICATION OF THE DEVICES BASED ON THEIR CONDITION,” and “OPERATIONAL CYCLE ANALYSIS,” and in connection with FIGS. 4 through 30.

### Hardware and System Related Description

FIG. 1 is a block diagram of a full handheld computer/host system 100, according to the embodiments as disclosed herein. As depicted in FIG. 1, the full handheld computer/host System 100 comprises of a Power Management Module 101, a User Interface 102, a communication module 103, a computing module 104 and a Battery 105.

Network link(s) involved in the full handheld computer/host system 100 may include any suitable number or arrangement of interconnected networks including both wired and wireless networks. By way of example, a wireless communication network link over which mobile devices communicate may utilize a cellular-based communication infrastructure. The communication infrastructure includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, network link may further include, or alternately include, a variety of communication channels and networks such as WLAN/Wi-Fi, WiMAX, Wide Area Networks (WANs), and Bluetooth.

The full handheld computer/host System 100 may be operably connected with (or included within) an enterprise network. The Enterprise network may further include one or more of email or exchange servers, enterprise application servers, internal application store servers, authentication (AAA) servers, directory servers, Virtual Private Network (VPN)/SSL gateways, firewalls, among other servers and components. Email or exchange servers may include Exchange Active Sync (EAS) or other functionality that provides synchronization of contacts, calendars, tasks, and email between Active sync enabled servers and mobile devices. Other synchronization products can also be used. The mobile devices may access or utilize one or more of these enterprise systems or associated functionality.

In certain embodiments, server and/or the mobile development service may be hosted and operated by one or more third-party service providers and/or may be accessed by developers through network using a developer computer. In certain embodiments, network may be any suitable type of wired and/or wireless network such as an Internet network or dedicated network that allows developers to access to the Communication Module 103 through developer computer. For example, as shown in FIG. 1, the Computing Module 104 may be in the form of a web server that can be accessed by developers through the Internet using developer computer.

Developers may access the full handheld computer/host System 100 by navigating to one or more web pages using a standard web browser on developer computer, thereby obviating the need to download and/or install separate software on a developer computer. In certain other embodiments, the Mobile Device Intelligence and Interaction Project may be a separate client or stand-alone software application that can be downloaded by developers from server and/or one or more other third-party servers, or may be provided to developers through any other suitable means (e.g., CD, physical disk, etc.) and installed on a developer computer. Although the Computing Module 104 is shown in FIG. 1 for illustrative purposes, it should be understood that in certain embodiments the functionality provided by the Computing Module 104, such as the mobile development service, may be hosted and operated by any number of servers, or may be integrated with the developer computer.

As depicted in FIG. 1, the User Interface (UI) module 102 may also include a display device, a processor accessible memory, or any device or combination of devices to which data is output. The UI module 102 interfaces with the Communication module 103 to obtain the captured images in real time and provides the captured images.

The Communication Module 103 is responsible for handling communication between ports and also acting as an interface between a built-in-port on the processor and another communication link with a different type of protocol.

The Computing Module 104 comprises a plurality of independent electronic circuits packaged onto a circuit board to provide a basic function within a computer. In further embodiments of the present invention, the full handheld computer/host System 100 is made up of one PC Board which contains communication ability such as Wi-Fi, Bluetooth and Qi, power management (battery charging) which is managed by the Power Management Module 101. Additionally, the full handheld computer/host System 100 comprises the User Interface 102 (LED Array) and computing abilities (processing, data storage, images), while the second component is the 5Ah Battery.

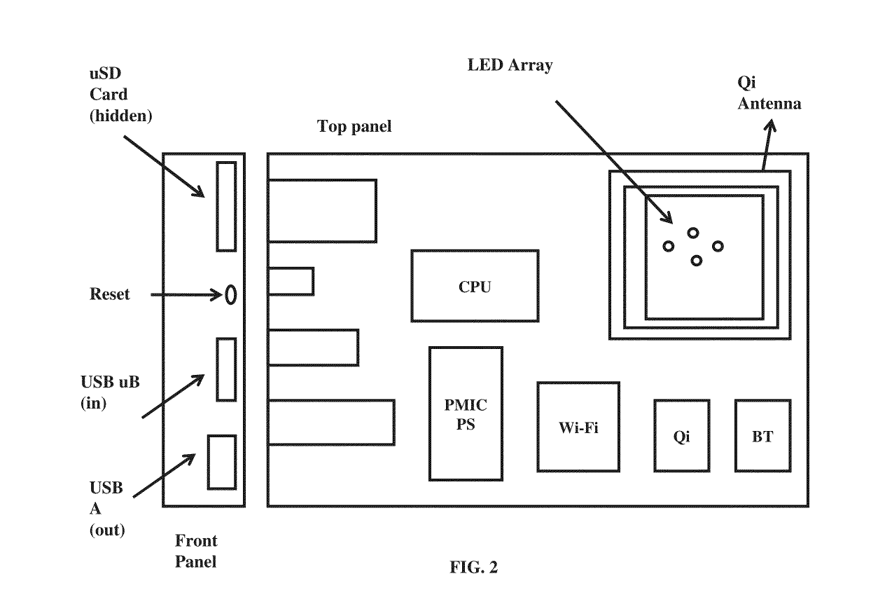

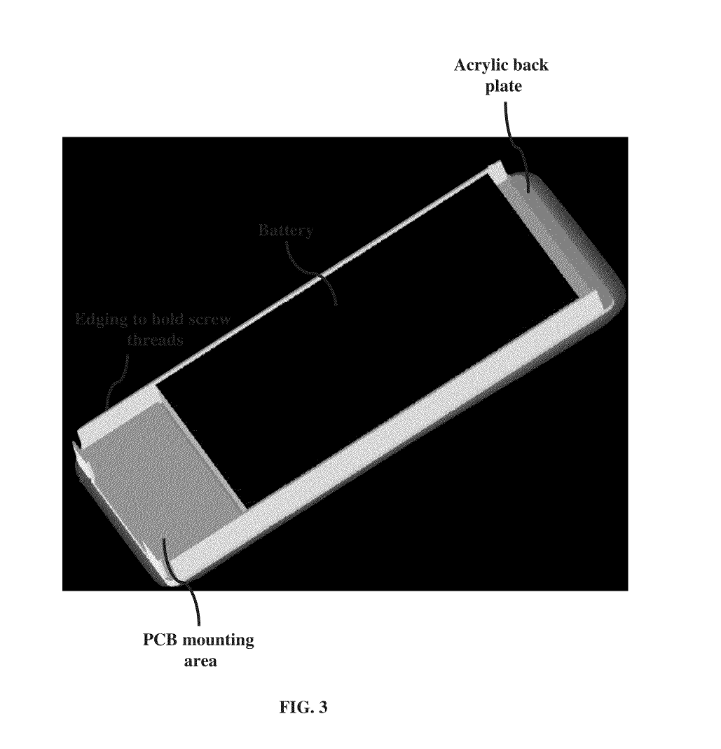

FIG. 2 illustrates a detailed schematic of the pc board, according to the embodiments as disclosed herein.

As depicted in FIG. 2, the pc Board comprises of a front panel and top panel. In the front panel there is provided a micro SD card slot, a reset button, a USB in and out port. The top panel comprises the LED array, CPU, a Qi Antenna and communication ports in the form of Wi-Fi, Qi and BT.

In an embodiment, using Single Band (2.4 GHz) Wi-Fi lowers costs as a single band Wi-Fi adapter is one of the cheapest working IC on the market. The use of a module reduces low volume costs, but integration is necessary for the most aggressive cost savings.

The Bluetooth component for example can be a Texas Instruments CC2450 programmable solution to support future upgrades. Further, Texas Instruments offers additional integrated transceivers that provide alternatives in the future if requirements change. Also, the Bluetooth component includes firmware.

The Battery 105 in an embodiment is a Li-ion type. The use of Li-ion batteries is considered risky but presents the lowest balance of system costs due to the wide employment of this battery type and the existence of full-featured PMIC's. The Battery 105 is quality tested where it includes an on-module safety circuit which requires deep and on-going factory inspection to reduce liability. Further, the Battery 105 provides 2.5 A sustained output at less than 10 degree Celsius of temperature rise.

For example, users may access the full handheld computer/host system 100 using a special-purpose client application hosted by a “mobile” device of the user (or a web- or network-based application using a browser client). The client application may automatically access Global Positioning System (GPS) or other geo-location functions supported by the “mobile” device and report the user's current location to the geo-social networking system. In addition, the client application may support geo-social networking functionality that allows users to check-in at various locations and communicate this location to other users. A check-in to a given place may occur when a user is physically located at a place and using the “mobile” device, access the geo-social networking system to register the user's presence at the place. A user may select given place may occur when a user is physically located at a place and, using the “mobile” device, access the geo-social networking system to register the user's presence at the place. A user may select a place from a list of existing places near to the user's current location or create a new place. The System 100 may automatically check in a user to a place based on the user's current location and past location data. An entry including a comment and a time stamp corresponding to the time the user checked in may be displayed to other users. For example, a record of the user's check-in activity may be stored in a database.

This present invention contemplates the full handheld computer/host 100 taking any suitable physical form. As example and not by way of limitation, the full handheld computer/host 100 may be an embedded computer system, a system-on-chip (SOC), a desktop computer system, a mobile computer system, a game console, a mainframe, a mesh of computer systems, a server, or a combination of two or more of these. Where appropriate, the full handheld computer/host 100 may include one or more full handheld computer/host 100; be unitary or distributed; span multiple locations; span multiple machines; or reside in a cloud, which may include one or more cloud components in one or more networks. Where appropriate, one or more full handheld computer/host 100 may perform without substantial spatial or temporal limitation one or more steps of one or more methods described or illustrated herein. As an example and not by way of limitation, full handheld computer/host 100 may perform in real time or in batch mode one or more steps of one or more methods described or illustrated herein. The full handheld computer/host 100 may perform at different times or at different locations one or more steps of one or more methods described or illustrated herein, where appropriate.

In particular embodiments, the full handheld computer/host 100 includes a processor, memory, storage, an input/output (I/O) interface, a communication interface, and a bus. In particular embodiments, processor includes hardware for executing instructions, such as those making up a computer program. As an example and not by way of limitation, to execute instructions, processor may retrieve (or fetch) the instructions from an internal register, an internal cache, memory, or storage; decode and execute them; and then write one or more results to an internal register, an internal cache, memory, or storage. In particular embodiments, processor may include one or more internal caches for data, instructions, or addresses. In particular embodiments, memory includes main memory for storing instructions for processor to execute data for processor to operate on. As an example and not by way of limitation, the full handheld computer/host 100 load instructions from storage to memory. Processor may then load the instructions from memory to an internal register or internal cache. To execute the instructions, processor may retrieve the instructions from the internal register or internal cache and decode them. During or after execution of the instructions, the processor may write one or more results (which may be intermediate or final results) to the internal register or internal cache. Processor may then write one or more of those results to memory. One or more memory buses (which may each include an address bus and a data bus) may couple processor to memory. The Bus may include one or more memory buses, as described below. In particular embodiments, one or more memory management units (MMUs) reside between processor and memory and facilitate accesses to memory requested by processor. In particular embodiments, memory includes random access memory (RAM). This RAM may be volatile memory, where appropriate, this RAM may be dynamic RAM (DRAM) or static RAM (SRAM).

In particular embodiments, storage includes mass storage for data or instructions. As an example and not by way of limitation, storage may include an HDD, a floppy disk drive, flash memory, an optical disc, a magneto-optical disc, magnetic tape, or a Universal Serial Bus (USB) drive or a combination of two or more of these. Storage may include removable or non-removable (or fixed) media, where appropriate. Storage may be internal or external to computer system, where appropriate. In particular embodiments, storage is non-volatile, solid-state memory. In particular embodiments, storage includes read-only memory (ROM). Where appropriate, this ROM may be mask-programmed ROM, programmable ROM (PROM), erasable PROM (EPROM), or flash memory or a combination of two or more of these.

In particular embodiments, I/O interface includes hardware, software, or both providing one or more interfaces for communication between system 100 and one or more I/O devices. The system 100 may include one or more of these I/O devices, where appropriate. One or more of these I/O devices may enable communication between a person and computer system 100. As an example and not by way of limitation, an I/O device may include a keyboard, microphone, display, touch screen, mouse, speaker, camera, another suitable I/O device or a combination of two or more of these. An I/O device may include one or more sensors. This disclosure contemplates any suitable I/O devices and any suitable I/O interfaces for them. Where appropriate, I/O interface may include one or more device or software drivers enabling processor to drive one or more of these I/O devices. I/O interface may include one or more I/O interfaces, where appropriate. Although this disclosure describes and illustrates a particular I/O interface, this disclosure contemplates any suitable I/O interface.

In particular embodiments, communication interface includes hardware, software, or both providing one or more interfaces for communication (such as, for example, packet-based communication) between computer system and one or more other computer systems or one or more networks. As an example and not by way of limitation, communication interface may include a network interface controller (NIC) for communicating with an Ethernet or other wire-based network or a wireless NIC (WNIC) for communicating with a wireless network, such as a WI-FI network. This disclosure contemplates any suitable network and any suitable communication interface for it. As an example and not by way of limitation, the full handheld computer/host 100 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the system 100 may communicate with a wireless PAN (WPAN) (e.g., a Bluetooth WPAN), a WI-FI network (e.g., a 802.11a/b/g/n WI-FI network), a WI-MAX network, a cellular telephone network (e.g., a Global System for “mobile” Communications (GSM) network, a Long Term Evolution (LTE) network), or other suitable wireless network or a combination of two or more of these.

In particular embodiments, bus includes hardware, software, or both coupling components of System 100 to each other. As an example and not by way of limitation, bus may include an Accelerated Graphics Port (AGP) or other graphics bus, an Enhanced Industry Standard Architecture (EISA) bus, a front-side bus (FSB), a HYPERTRANSPORT (HT) interconnect, an INFINIBAND interconnect, a low-pin-count (LPC) bus, a memory bus, a Peripheral Component Interconnect Express or PCI-Express bus, a serial advanced technology attachment (SATA) bus, an Inter-Integrated Circuit (I2C) bus, a Secure Digital (SD) memory interface, a Secure Digital Input Output (SDIO) interface, a Universal Serial Bus (USB) bus, a General Purpose Input/Output (GPIO) bus, or another suitable bus or a combination of two or more of these. Bus may include one or more buses, where appropriate.

The client-side functionality described above can be implemented as a series of instructions stored on a computer-readable storage medium that, when executed, because a programmable processor to implement the operations described above. While the client device 104 may be implemented in a variety of different hardware and computing systems.

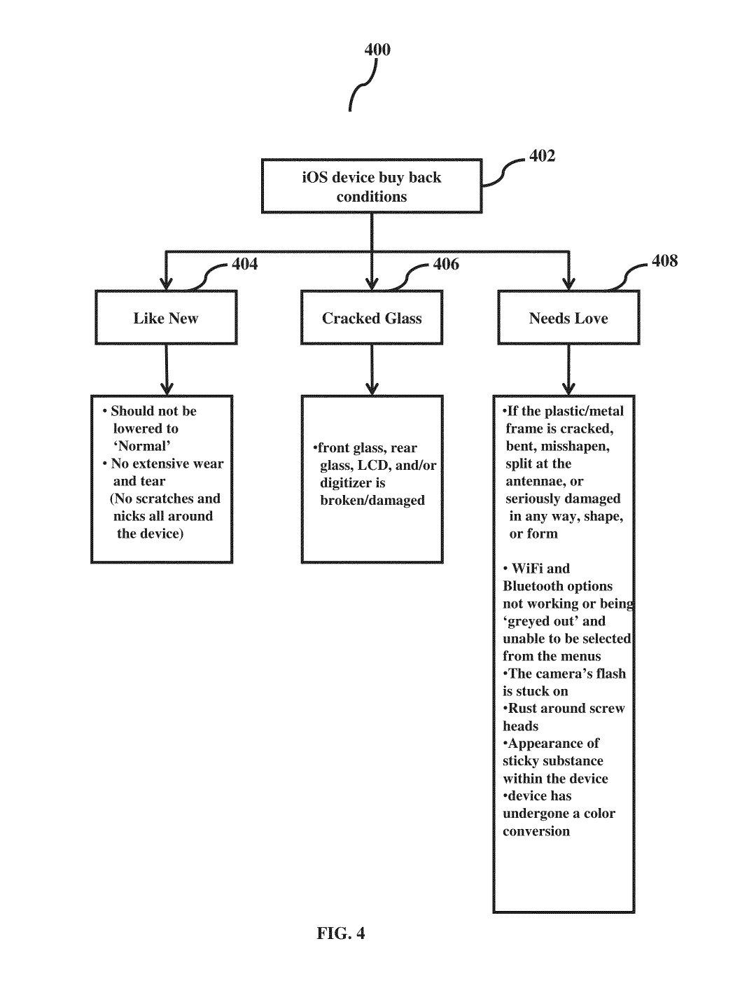

FIG. 3 depicts the finished enclosure of a computing device, according to the embodiments as disclosed herein. The enclosure of the computing device is finished in a way such that there is ample metal and gloss finishes and the overall finishing job is done at a cheap cost. For example, the size of the enclosure may be as much as 75 mm*150 mm*10 mm (although smaller enclosures are possible) to fit internal components and the enclosure is finished in such a way keeping in mind that internal components must remain accessible for field upgrades and return service.

The design concept involves fitting an LED Array behind the top cover panel to backlight various sections of that panel. These sections may be illuminated on command to indicate the status of various hardware sub-systems, such as the Wi-Fi or Bluetooth radios. These backlit regions may be positioned on the top cover panel to comply with artistic or industrial design goals. Diamond polished flat head screws are used to attach upper and lower frames. The acrylic plates are easily colored, textured, or patterned. The Aluminum frame is polished finer on cut edges thus providing a shiny, high gloss surface. As depicted in FIG. 3, the acrylic back plate is glued to the inner frame for rigidity and strength with an inner ABS plastic frame, edging to hold screw threads and a PCB mounting area.

### Exemplary System Architecture

FIG. 31 is a block diagram of a machine in the example form of a computer system 3100 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3100 includes a processor 3102 (e.g., a central processing unit (CPU), a graphics processing unit (GPU), or both), a main memory 3104, and a static memory 3106, which communicate with each other via a bus 3108. The computer system 3100 may further include a video display unit 3110 (e.g., a liquid crystal display (LCD) or a cathode ray tube (CRT)). The computer system 3100 also includes an alphanumeric input device 3112 (e.g., a keyboard), a user interface (UI) navigation device 3114 (e.g., a mouse), a disk drive unit 3116, a signal generation device 3118 (e.g., a speaker), and a network interface device 3120.

The computer system 3100 may also include a environmental input device 3126 that may provide a number of inputs describing the environment in which the computer system 3100 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 3116 includes a machine-readable medium 3122 on which is stored one or more sets of data structures and instructions 3124 (e.g., software) embodying or utilized by any one or more of the methodologies or functions described herein. The instructions 3124 may also reside, completely or at least partially, within the main memory 3104 and/or within the processor 3102 during execution thereof by the computer system 3100, the main memory 3104 and the processor 3102 also constituting machine-readable media.

While the machine-readable medium 3122 is shown in an example embodiment to be a single medium, the term “machine-readable medium” may include a single medium or multiple media (e.g., a centralized or distributed database, and/or associated caches and servers) that store the one or more instructions 3124 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 3124 may further be transmitted or received over a computer network 3150 using a transmission medium. The instructions 3124 may be transmitted using the network interface device 3120 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al.). In one example, signals from the computer can be transferred, at least in part, wirelessly to components or other computers.

### Process Description of the Current Method to Evaluate the Condition of the Hardware Elements and in Turn Determining the Buy Back Price of the Phone

FIG. 4 depicts the categories of a used computing device to evaluate the price of a device buy back condition and also to accurately determine the current condition of the client device, according to the embodiments as disclosed herein. As depicted, the method 400 describes the buyback conditions for a computing device after evaluating the condition of the client device 104. For the purposes of illustration, we can consider the computing device to be an iPhone. The Buy back conditions are classified into fields such as Like New (404), Normal (406) (Cracked glass) and Needs love (408).

The colloquial term “Needs Love,” used as a particular illustrative embodiment throughout the present specification, signifies that the client device 104 requires a substantial amount of repair and servicing to be done. It thus may be regarded as synonymous with a more descriptive and generic term such as “needs repair”.

In an embodiment, the difference between “Like New” and Normal is considered small and offers based on these two conditions only differ by a little. If the consumer has diagnosed the device as “Like New”, then it is likely to diagnosed as “Like new” and should not be lowered to “Normal”, unless there is extensive wear and tear such as scratches and nicks all around the device. The cracked glass condition is considered as normal except if the front glass, rear glass, LCD, and/or digitizer is broken and damaged. A device with the aforementioned problems but does not meet any of the “Needs Love” requirements is still considered as a Cracked Glass Condition.

In an embodiment the Needs Love condition is met when the computing device needs a few repairs. For example, a jammed button that does not click perfectly is classified into the Needs Love condition. Also, if the plastic or metal frame of any device is cracked, bent, misshapen, or split at the antenna or seriously damaged in any way, shape or form then the device is considered to be in the “Needs Love condition”. In case, the computing device looks normal and the water damaging sensors in the charging port, headphone, jack or the SIM card tray are still white and however if the software is slightly buggy, it is necessary to open the device to check for further errors. In case, the internal sensors are not red, then the device is considered to be in Normal condition. However, if the internal sensors are red in color, then the device is classified to be in “Needs Love” condition.

Further, in case the internal sensors are OK then the device is considered to be in “Needs Love” condition, where the factors which can be alerted to water damage are conditions such as Wi-Fi and Bluetooth options not functionally properly or the screen being grayed out and hence these options are unable to be selected from the menus. Other factors include camera flash being stuck, rust formation around the screw heads, and appearance of sticky substance within the device. Engravings on the device devalue a device so even if the device is in “Like New Condition” but has an engraving then it is considered to be in “Needs Love condition” since these engravings have to be removed.

Once the bottom screws of the computing device are examined and it is clear that they have been stripped and if the device looks like it has been opened up and repaired or tampered with then it is most likely that there will be other signs of disfunctionality that needs to be looked into. For example, the device may have undergone a color conversion which includes changing from black to white and white to black and for this it is necessary to check the charging port and headphone jack to confirm whether the issue exists.

Listed below is a few examples of how the computing device is classified under various conditions:

Classification of the Devices Based on their Condition

### Like New:

Works perfectly

Has little to no scratches or nicks on the screen or frame

All buttons click well and are not jammed

Has never been wet

### Normal:

Works perfectly

Has minor scratches or nicks on the screen or frame

All buttons click well and are not jammed

Has never been wet

### Cracked Glass:

**In Normal condition, except one or more of the following are true**
Front glass cracked
Rear glass cracked
LCD broken
Digitizer does not recognize touch Needs love:
Does not power on (Or does not remain on normally)
Jammed, missing, or malfunctioning buttons
Malfunctioning vibrator
Water damaged (Even if it still functions)
Has an engraving
Serious physical damage (Bent/cracked frame, missing hardware, device in pieces)
Has been repaired before (not by an iTech or iCracked)
Has been color converted
Stuck in Boot Loop
Jailbroken.

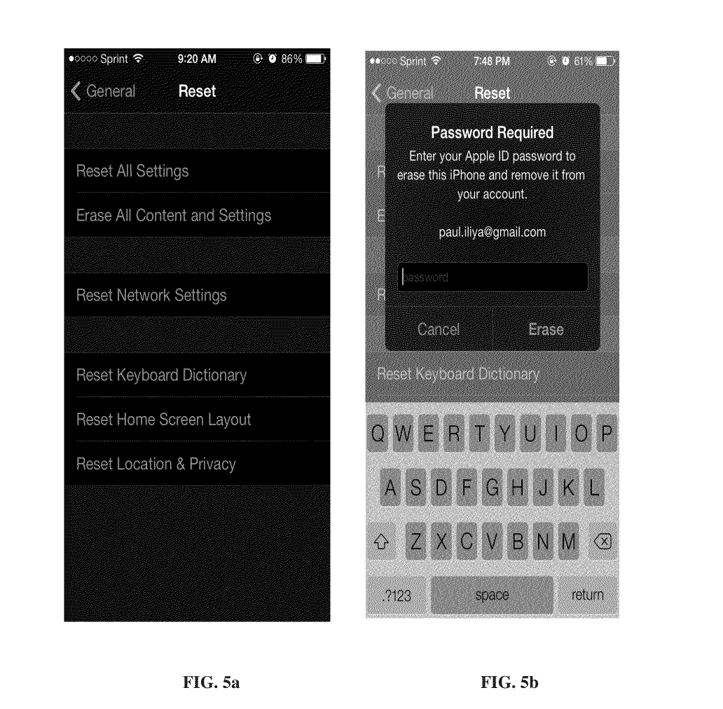

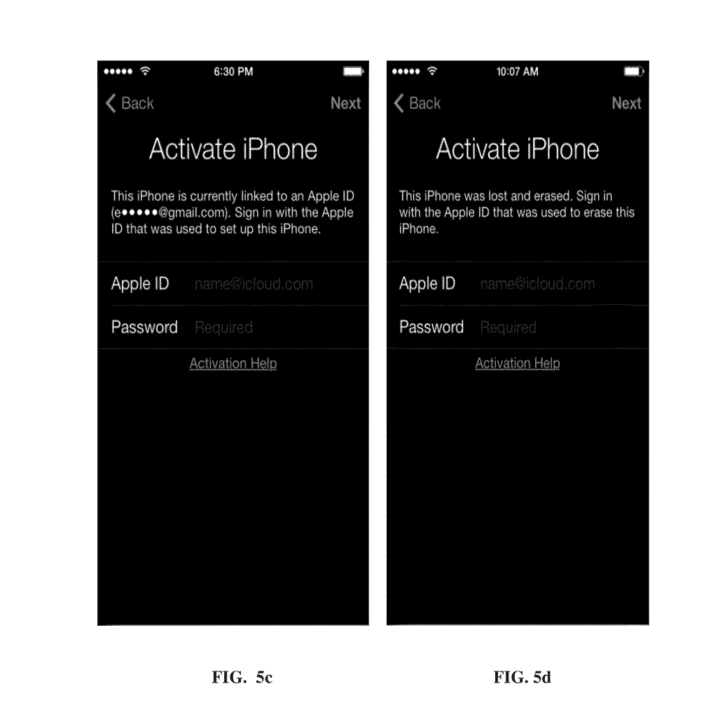

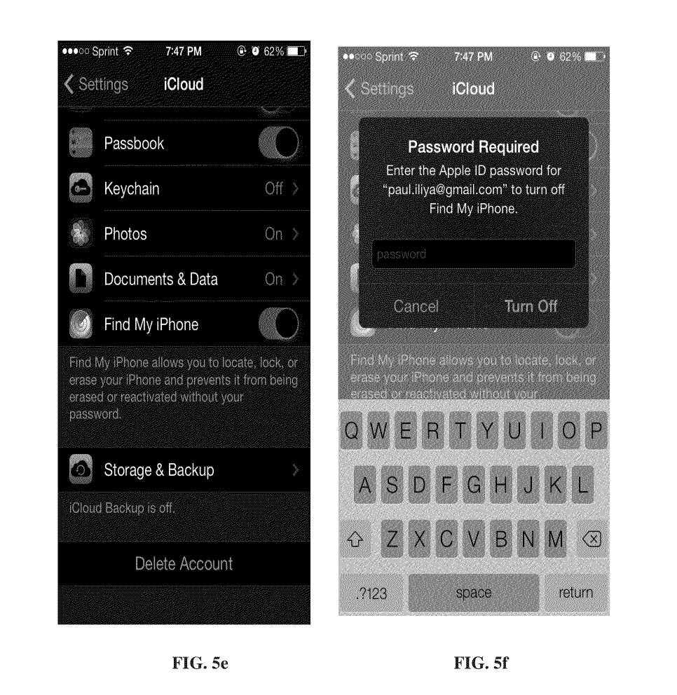

FIGS. 5a and 5b, 5c and 5d, 5e and 5f, depict the various stages of find my computing activation guide, in case the device is lost or stolen, according to the embodiments as disclosed herein. Listed below are the ways to determine if the activation lock is enabled for iPhone.
a. After checking the internal settings and IMEI of the computing device, the customer is required to wipe the device. Wiping the device signifies that all the data in the client device 104 is erased before servicing, so that the client device 104 is factory reset. If the device asks for an iCloud account password after a wipe is attempted, then the device is still connected to an iCloud account. The customer will need to enter in the correct iCloud password in order for the wipe to be cleared.
b. When presented with a computing device that is already wiped, it is necessary to activate the device and take it from the beginning Hello screen to the Home screen. If at the point of connecting the device to its assigned cellular network, the computing device asks for an iCloud account password, then the device is still connected to an iCloud account. The customer will need to enter in the correct iCloud account password so that the device is completely activated.
c. The device may also indicate that the device has previously been lost and erased. Before the device can be reactivated in this instance, an iCloud account email and password is required to proceed.
d. After checking the internal settings and IMEI of the device, it is necessary to walk the customer through wiping their device. The device will again ask for an iCloud account password and it is required to enter that password one last time in order for the wipe to be completed.
   Settings>iCloud>Find My iPhone
e. In order to detect whether or not a device still has Find my iPhone turned on one has to navigate to Settings>iCloud. If the Find My iPhone is slider is green, then the find my iPhone activation lock is enabled and if the slider is tapped to turn it off, the device will ask for an iCloud account password in order to Find my iPhone to be disabled. The customer is required to enter in the correct iCloud account password in order for Find My iPhone to be disabled on that computing device.

In an embodiment, a software library is used that allows the present invention to build programs for performing various actions on a plurality of mobile devices at once. The software library is the core portion of the software that runs on a plurality of hardware devices. The core of this software application is a process that constantly monitors one or more USB connections to check when a mobile device is connected. When a device is connected, the software program sends device information to various clients in a variety of different protocols which is currently supported by Bluetooth and Websockets.

The software application allows additional tasks to be performed on the connected devices such as restoring device from a specific IPSW file, retrieving specific data from the phone, checking if the phone is part of a FMIP account, checking activation status with Apple servers, obtaining paired and unpaired device info, checking whether the user has password protected the device, retrieving battery and sensor diagnostics, putting the device into recovery or DFU mode, performing device firmware upgrades and so on.

### Operational Cycle Analysis

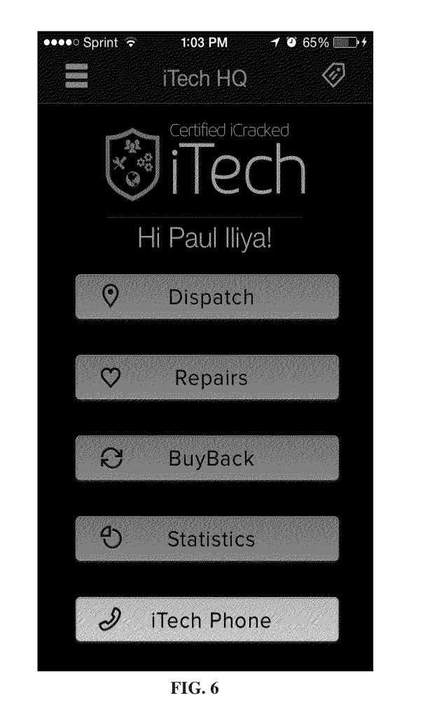

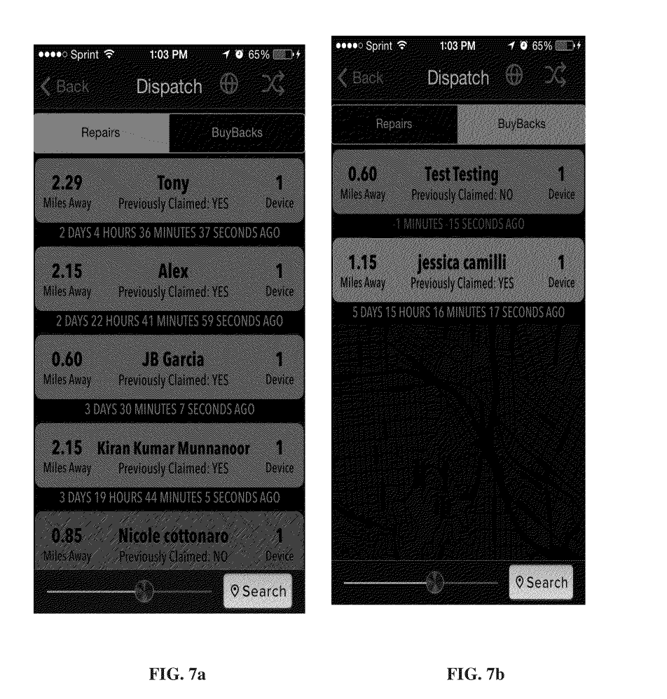

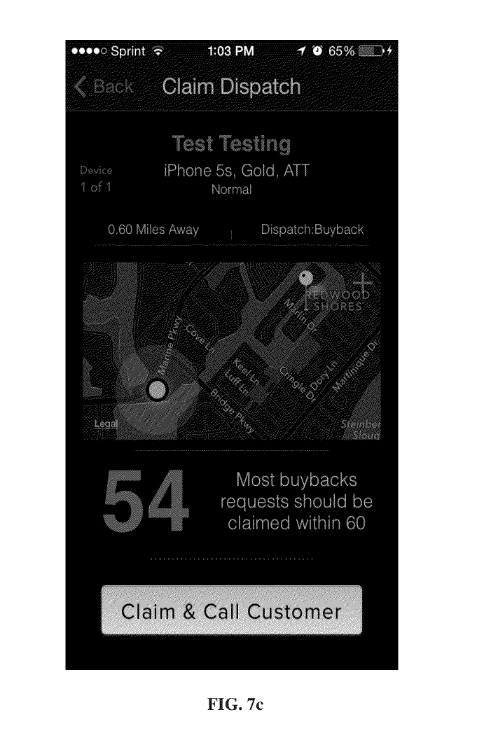

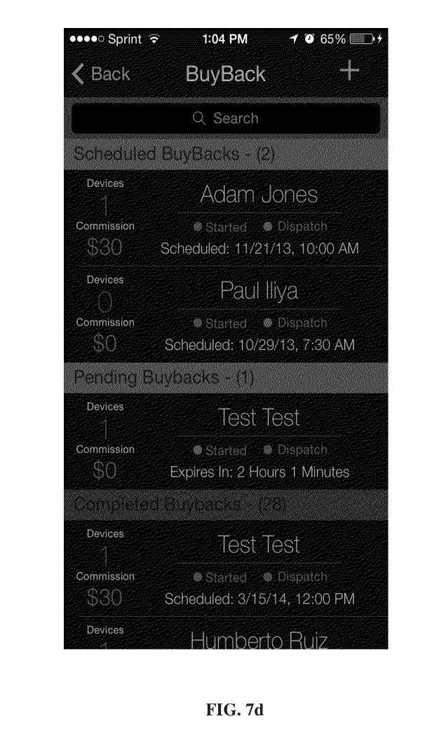

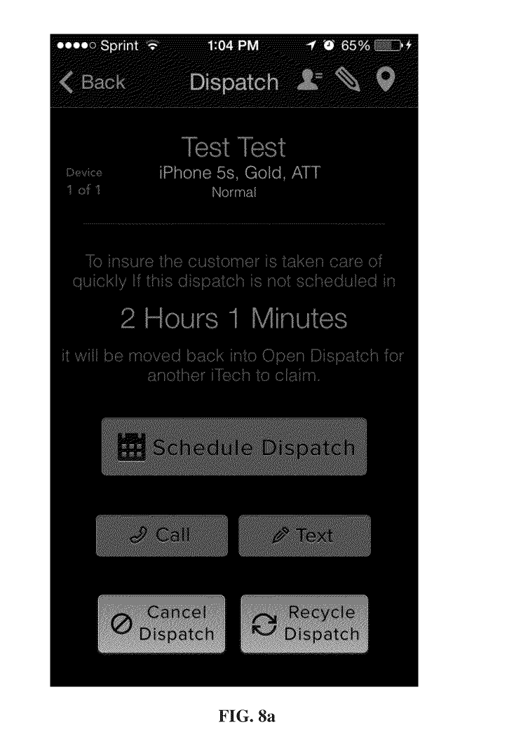

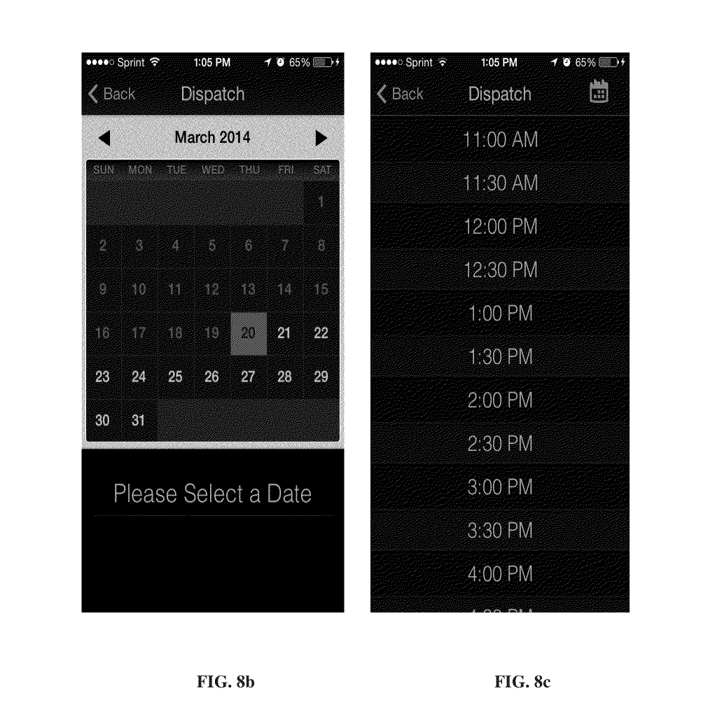

FIG. 6 to FIG. 30 depict the entire operation cycle of the buyback/repair cycle process, according to the embodiments as disclosed herein.

FIG. 6 is a screen shot depicting the user interface of the client device 104 when the technician uses it to repair or evaluate the buy back price of the phone, according to the embodiments as disclosed herein.

FIGS. 7a to 7d depict screen shots of location of the customers, dispatch schedules and other essential parameters such as scheduled, pending and completed tasks, according to the embodiments as disclosed herein.

The first part of the process is described as (although it is to be understood that the operations listed below can be implemented in a non-sequential manner or removing one or more steps):

Step 1: Claim the Buy Back Dispatch or Manually Input it

Once a customer has visited the website and provided the required information along with their requirements, the customer sends out a dispatch similar to a repair.

In order for a customer to sell their devices, they are also provided with the option of manually inputting the information into the app so that it does not have to come through dispatch. To manually enter in an ODB, it is necessary to first obtain the same information that the website takes in order to create a dispatch such as customer name, phone number, email address, and other related parameters. The application enquires with the technician to schedule the buyback similar to a repair request that came from dispatch in the beginning of the operation.

Upon meeting back up for the ODB and if it is not occurring at the time of input, the technician will then enter all of the devices the customer is selling into the application. This process will proceed in the order of device, carrier, capacity, color and condition. Once the information is entered, the technician can receive and communicate to the customer the offer for each device as they are entered on a real time basis. The ODB will proceed to other operations from this point.

Step 2: Schedule the Express Sale

This process is similar to one as Repair but with a few minor changes:

Since an on-demand only takes about 5-15 minutes and can be executed almost at any location, the technician can schedule his stopover at a convenient place and time. However, in an embodiment, the buyback process within the app requires good connectivity as it is necessary to schedule the buyback in a place that provides free Wi-Fi or an equivalent type of internet connection with strong connectivity.

### Data Security and Erasing Data:

It is mandatory to check if the customer has already erased their device to wipe out the data, to reactivate it and to bring the device back to the home screen before arriving at the location. This allows the technician to access the settings and test all internal settings beforehand. If the customer has not erased their device, it is necessary to help them erasing the device of it's data on the spot. It is also required to inform the customer that if their device is connected to the icloud account, they will need to remove it from the icloud account at this step and so it is doubly necessary to have their Apple ID or similar device identification and password information readily available.

The customer should be instructed to leave the SIM card in the device which allows the technician to reactivate the client device 104 if they need to.

FIGS. 8a to 8c are screenshots depicting meeting schedules for the scheduled dispatch, according to the embodiments as disclosed herein.

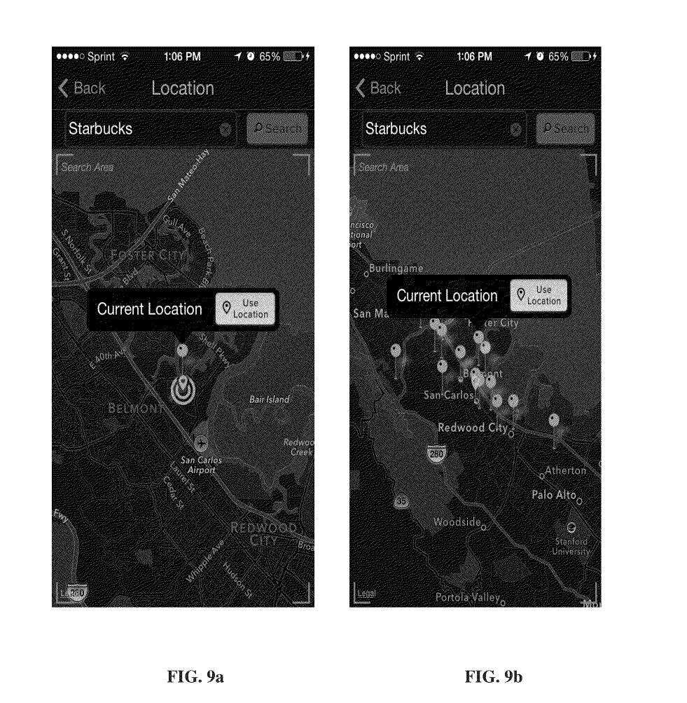

FIGS. 9a and 9b are screenshots depicting the location maps of the customer's desired meeting point, according to the embodiments as disclosed herein.

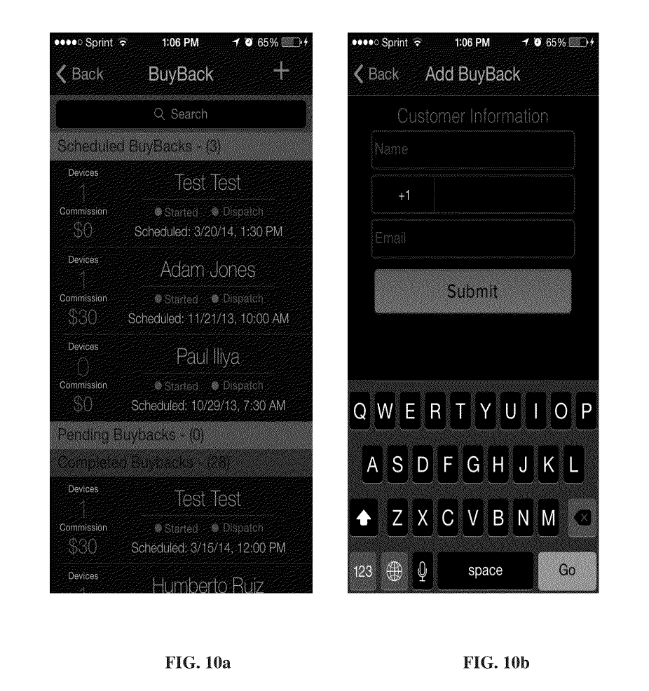

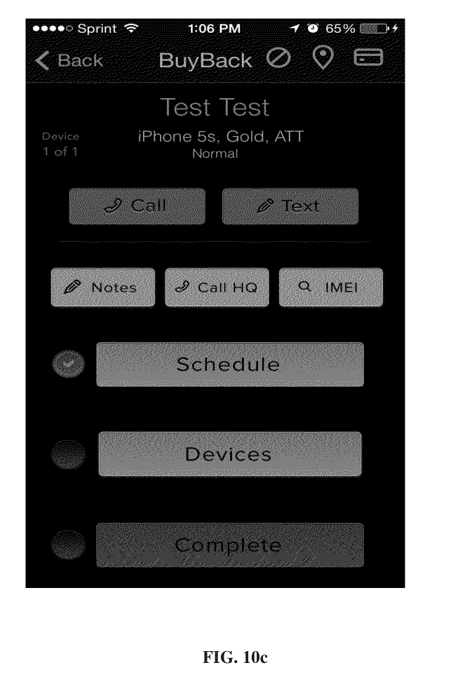

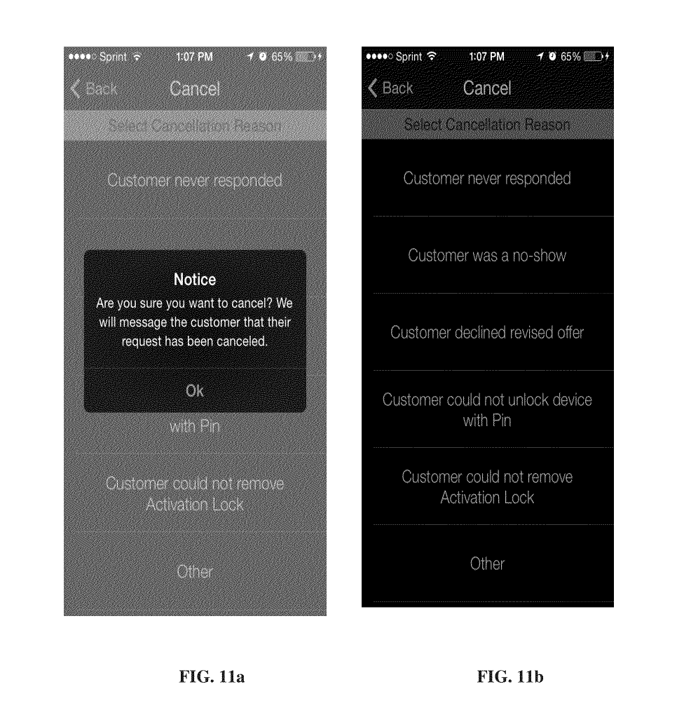

FIGS. 10a to 10c are screenshots depicting more examples for scheduled buybacks, according to the embodiments as disclosed herein.

FIGS. 11a and 11b are screenshots depicting customer responses on the user interface of the technician's client device, according to the embodiments as disclosed herein.

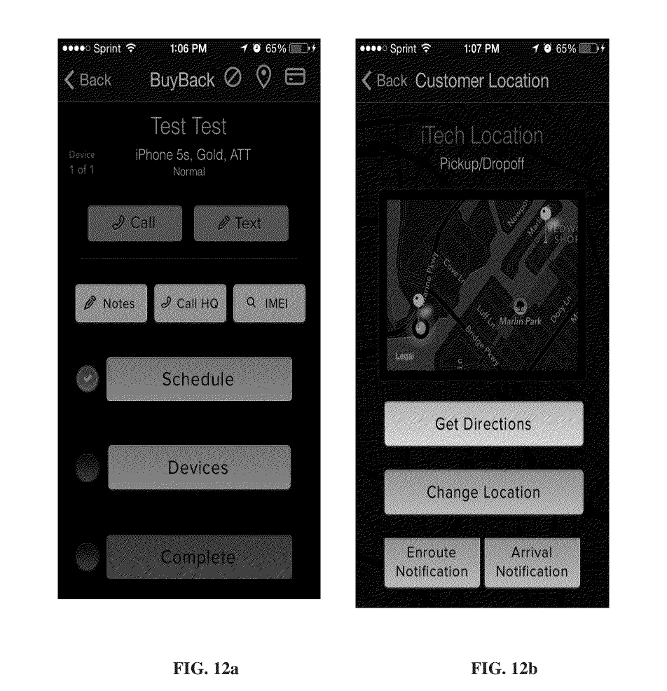

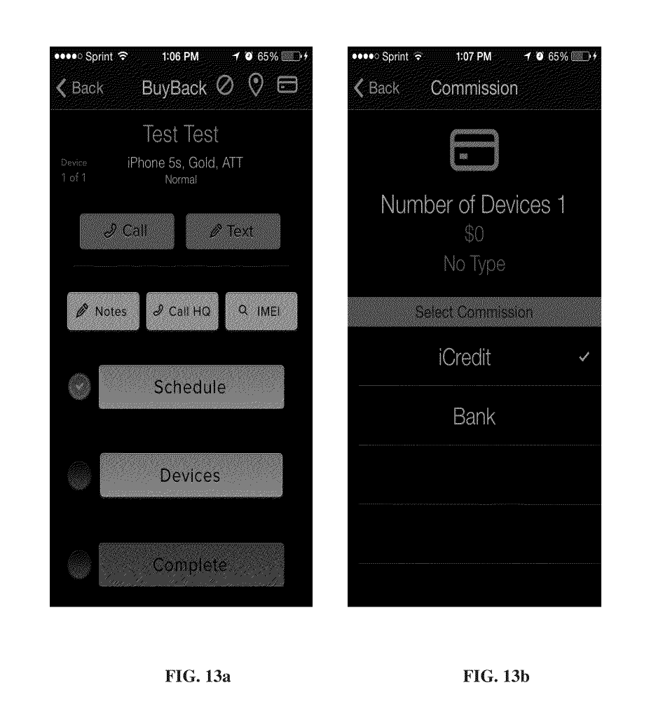

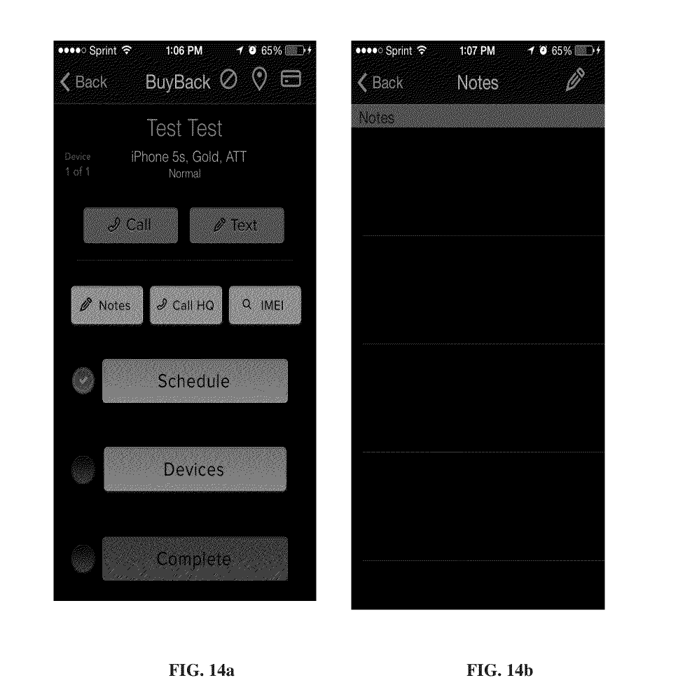

FIGS. 12a to 17b are screenshots depicting various implementations of the buy back procedure, according to the embodiments as disclosed herein.

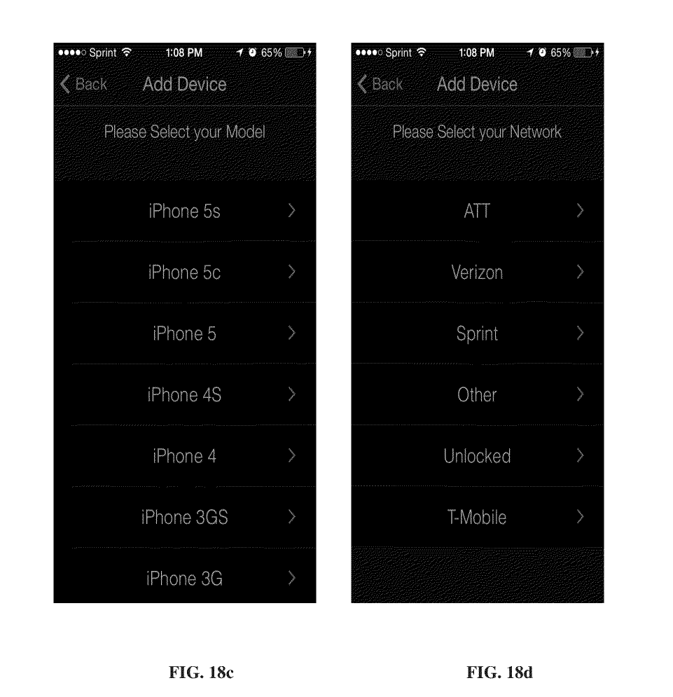

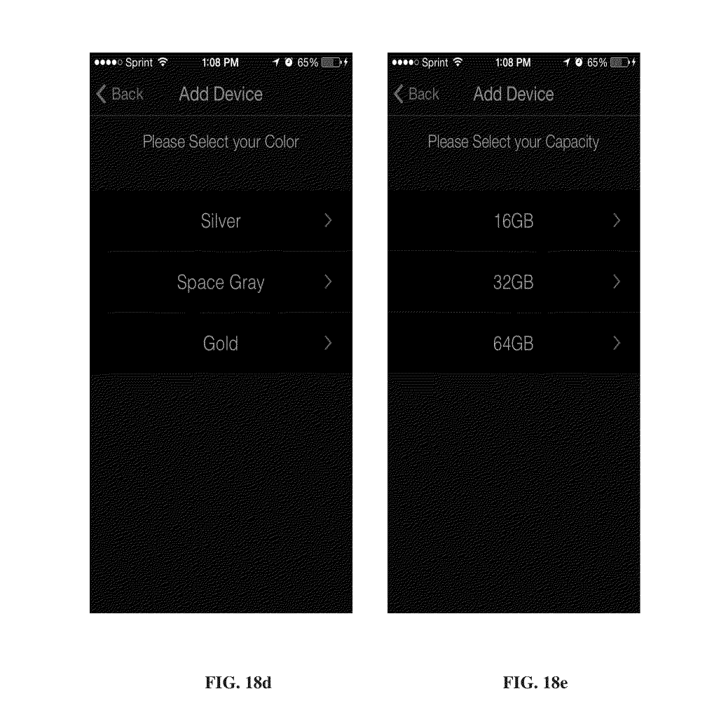

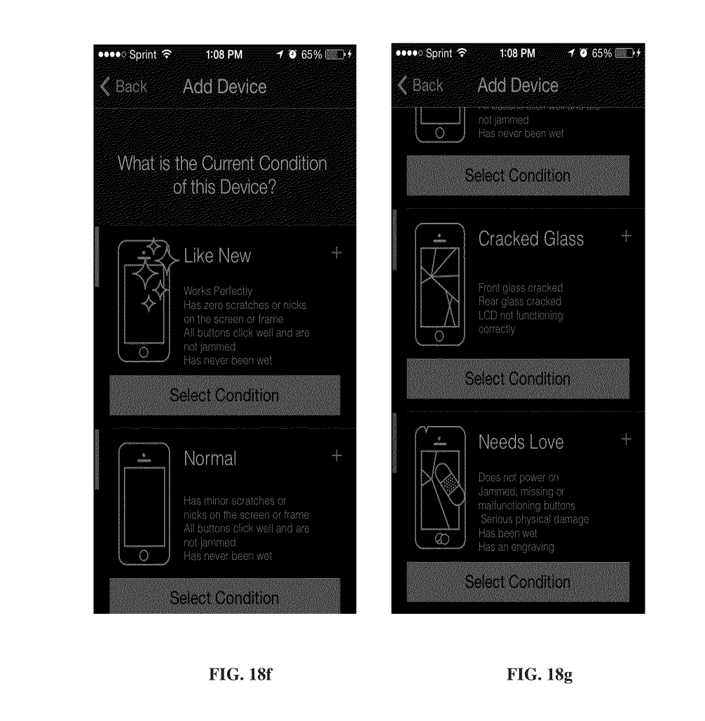

FIGS. 18a to 18e are screenshots depicting different models of client equipment which can be serviced or repaired, according to the embodiments as disclosed herein.

FIGS. 18f and 18g are screenshots depicting various categories of the client equipment, according to the embodiments as disclosed herein.

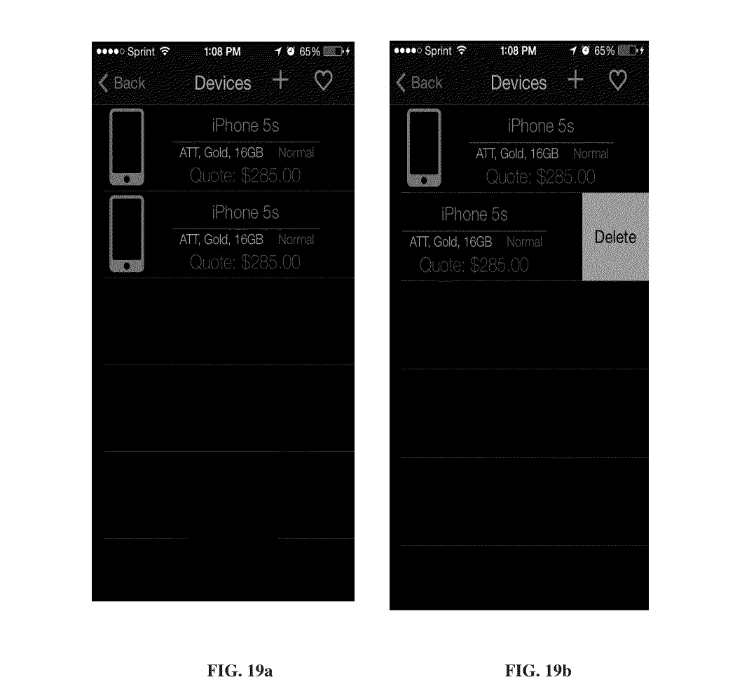

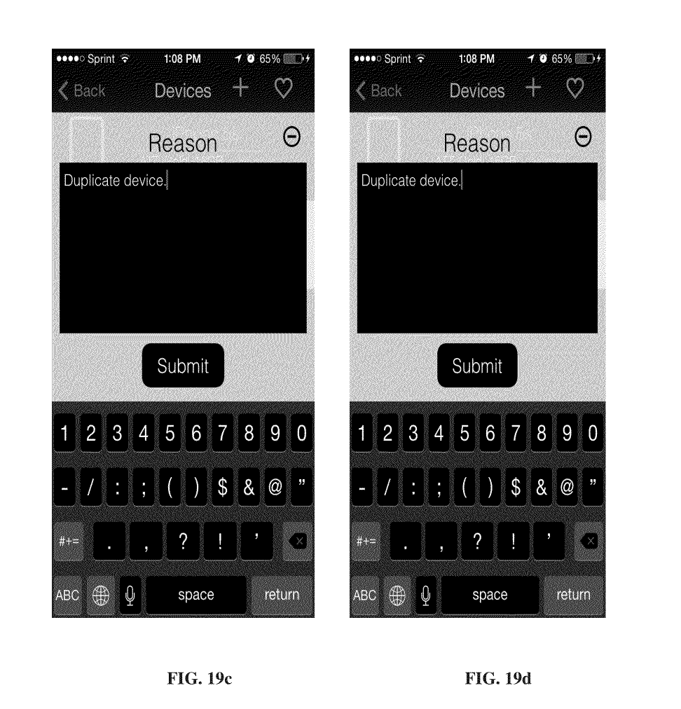

FIGS. 19a to 19d are screenshots depicting quotes and user interface of the client equipment, according to the embodiments as disclosed herein.

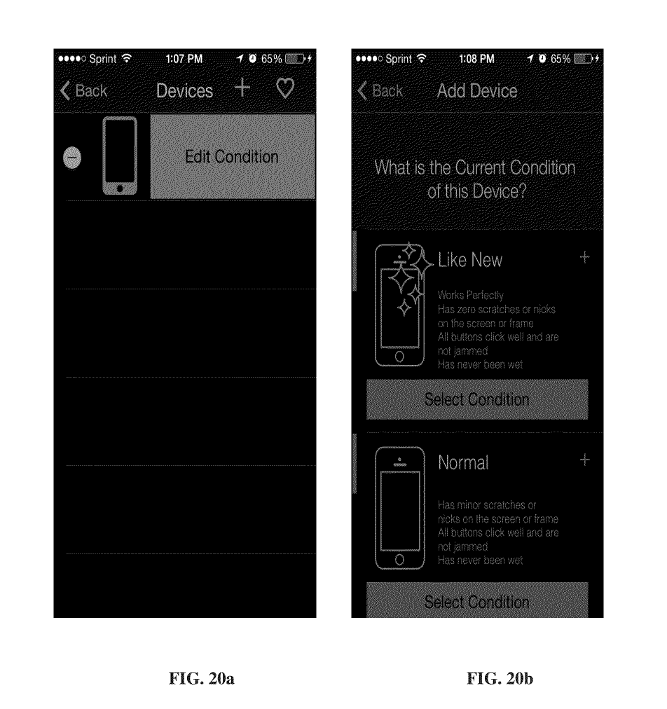

FIGS. 20a and 20b are screenshots depicting current condition of the client equipment, according to the embodiments as disclosed herein.

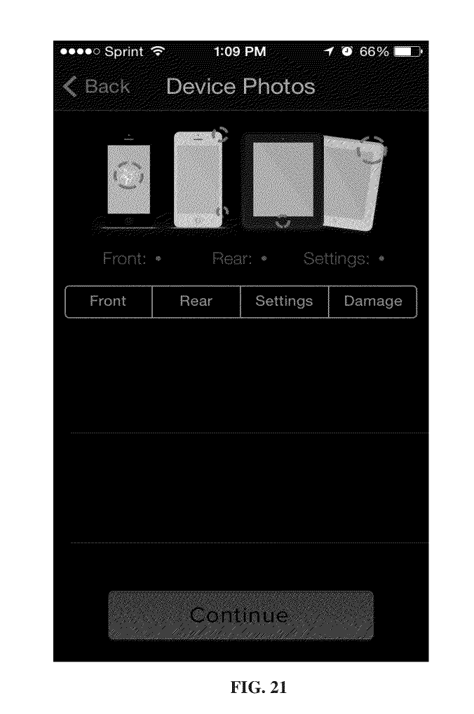

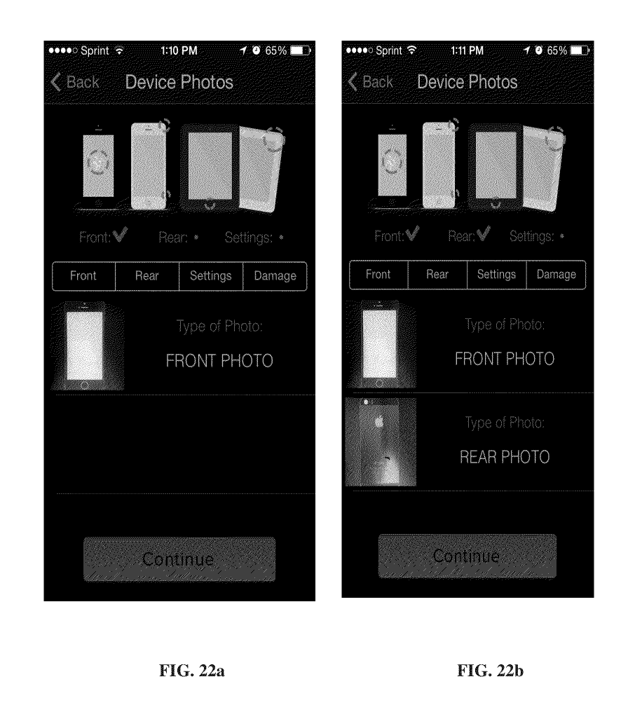

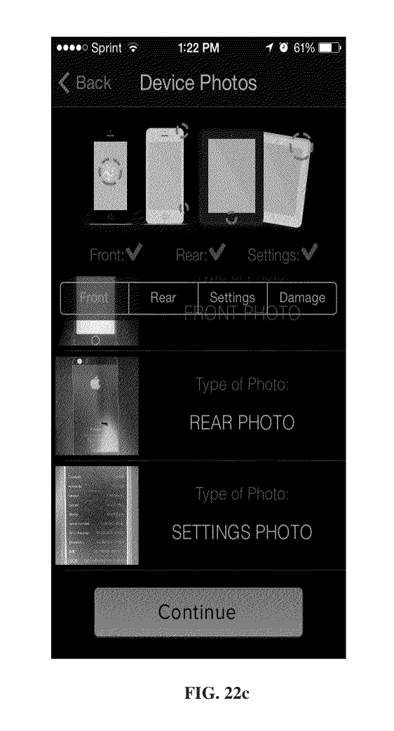

FIGS. 21 to 22c are screenshots depicting the mobile application of the client equipment, according to the embodiments as disclosed herein.

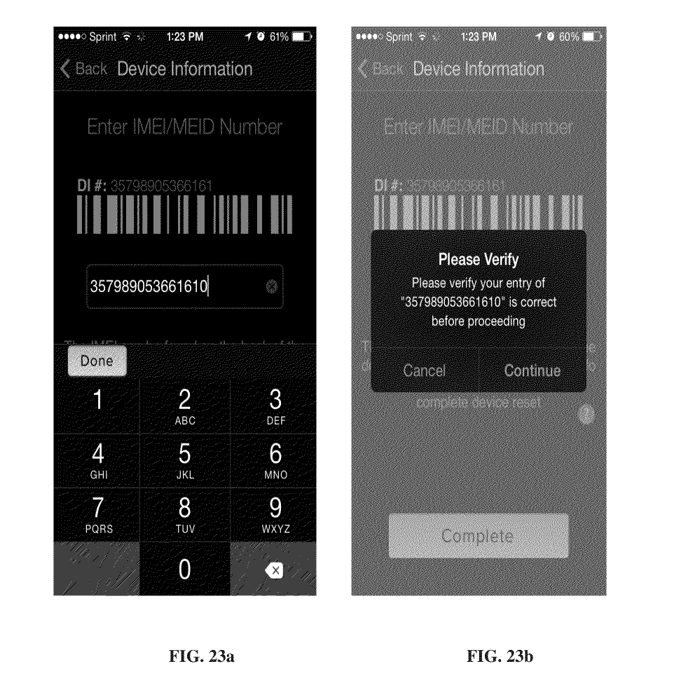

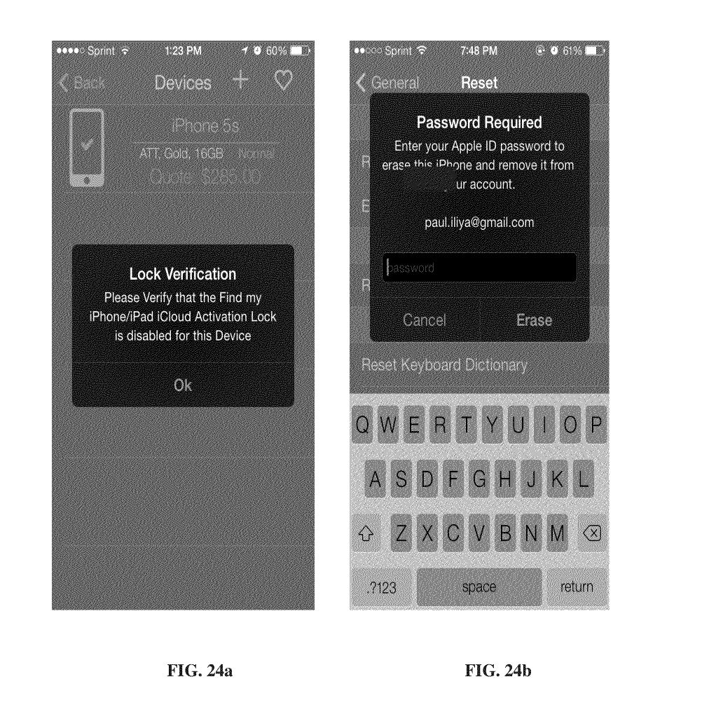

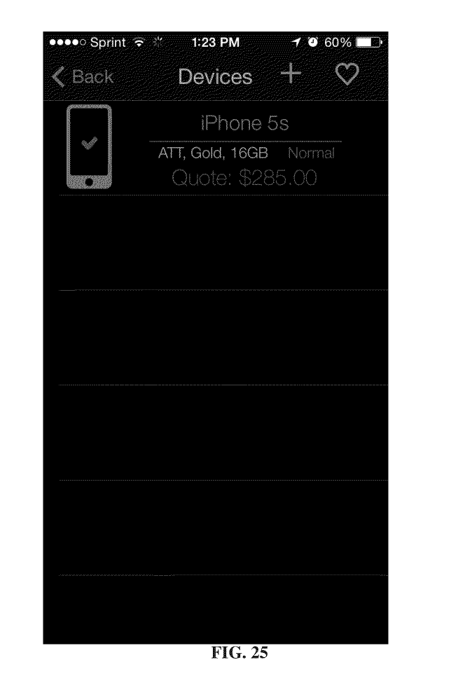

FIGS. 23a to 24b are screenshots depicting verification procedure, according to the embodiments as disclosed herein.

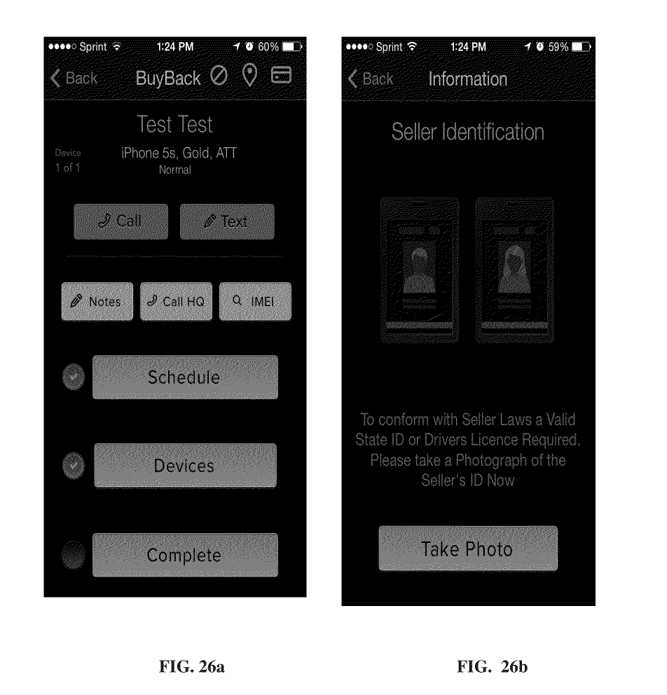

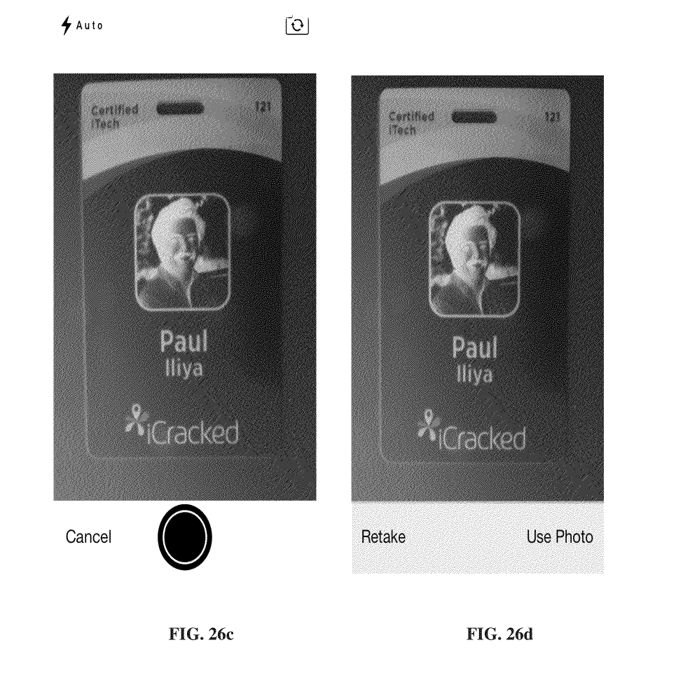

FIGS. 25 to 26e are screenshots depicting identification and verification procedure, according to the embodiments as disclosed herein.

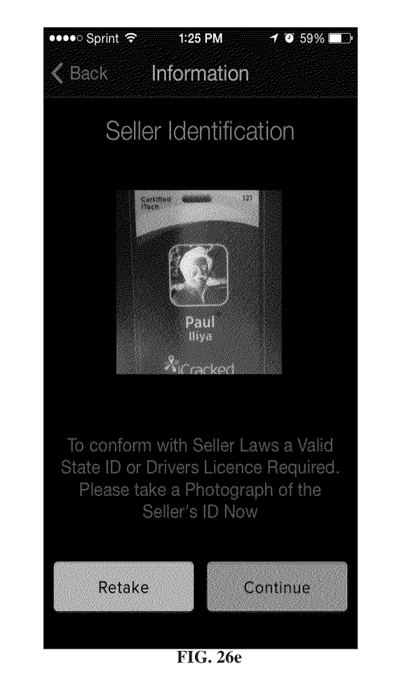

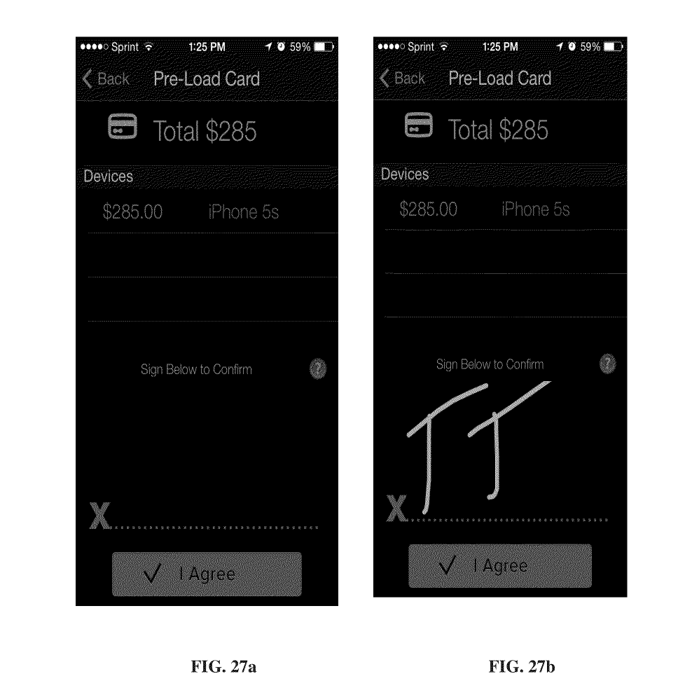

FIGS. 27 to 30 are screenshots depicting the final approval and completion procedure of the buyback/repair process, according to the embodiments as disclosed herein

### Payment

When the customer chooses to sell their device via Express sell, they will be paid/credited with a service known as “prepaid Master card debit card”. This card is iCracked Branded and is loaded on the spot with the total amount of the offer when the express sale is completed and processed. This debit card can be used for transactions at all authorized places or wherever entitled to. The card can be sealed in an envelope or in any other suitable package with its respective Cardholder Agreement and the first person to open the envelope will be the customer or his authorized representative. In order to activate the number, the number mentioned on the card should be dialed.

After this activation step, the customer needs to set a 4 digit PIN and billing zip code similar to what a person would do with a normal debit card and the funds on the card instantly become available.

### Redistribution

The devices are shipped directly to HQ (Head Quarters) from the technician within 72 hours of completion of an express sale. These devices are then made to undergo further checks to ensure they are not lost or stolen, and then they are sorted out to be given a fresh lease of life or responsibly recycled. The devices are generally either resold both domestically and internationally, or recycled in order to prevent harmful e-waste from ending up in the landfills or any other known disposal area.

### Technician's Kit and Instructions

When the technician enters a location with Free Wi-Fi or suitable internet connecivity, it is required to connect to the network at the earliest before initiating contact with the customer. The sealed prepaid debit card is provided and if the total buyback offer is more than 500$, then two or more envelopes is required as the offer may be split onto two cards. A device examination mat is provided to take the device pictures on to provide quick tips and information for the technician if needed during the sale. Also or alternately provided are SIM Card Tray opening tool, Pentalobe screwdriver, and Tweezers. The SIM card tray opening tool is used in order to remove, or insert any preexisting SIM card and bring back the original SIM card. The Pentalobe Screw Driver is used to remove the rear glass of an iPhone 4 or 4s to double check for water damage or previous tampering/repair work. The tweezers are used to clean dust and dirt out of the charging port in order to clearly check the water damage sensor.

Further, Inactive SIM cards and Prepaid USPS Priority Mail Shipping Label and Box are the other goods provided. In an embodiment, in order to reactivate an iPhone that has been wiped, which is at the hello screen or at the start up interface and in order to get it to the home screen an Inactive SIM card can be used. Additionally, when an on-demand buyback is officially scheduled within the app, the technician will instantly be emailed or provided with a prepaid shipping label for them to send the device to the HQ. In case, the technician has multiple ODB's lined up in the space of 1 to 2 days, the technician can ship all of the devices together in one box so that it meets the 72 hour time requirement to ship the devices associated with one buyback.

### Examination of the Device

The technician is required to check the model number which is an important determining factor before proceeding with the physical examination and taking pictures of the device. The model number is usually accessible to the technician since it is physically on the outside of the device, unless there is some sort of serious physical damage or if there is missing hardware.

Next, every physical aspect needs to be examined twice over to make sure that the customer diagnosed the device to be in the correct condition as even the tiniest of cracks or the slightest jam of a button can alter the buyback price for the device and segregate it to a different category.

The order for checking these aspects is outlined below to be the most efficient way so the process and sale can remain smooth and clear to the customer:

### Power Button

If the Power Button is jammed, does not click, or operates different in any way, shape, or form from what it would operate like on a brand new iPhone, then the device is in the ‘Needs Love’ condition. If the customer did not diagnose their device correctly as ‘Needs Love’, then it is necessary to inform the customer this will negatively affect their offer, and then revise the buyback request within the app to display the revised terms and conditions of the offer.

### Home Button

If the Home Button is jammed, does not click, or operates different in any way, shape, or form from what it would operate like on a brand new iPhone, then the device is in the ‘Needs Love’ condition

If the customer did not diagnose their device correctly as ‘Needs Love’, then it is necessary to inform the customer this will negatively affect their offer, and then revise the buyback request within the app to display to them the revised terms and conditions.

### Volume Buttons

If either of the Volume Buttons is jammed, does not click, or operates different in any way, shape, or form from what it would operate like on a brand new iPhone, then the device is in the ‘Needs Love’ condition. If the customer did not diagnose their device correctly as ‘Needs Love’:, the customer needs to be informed of the revised terms and conditions.

The device has to be activated, and the Home screen should be able to display the action of pressing these buttons which actually raise/lower the volume when the device is on.

### Mute/Vibrate Switch (and Vibrate Motor)

If the Mute/Vibrate Switch is jammed, does not switch back and forth, or operates different in any way, shape, or form from what it would operate like on a brand new device, then the device is in the ‘Needs Love’ condition. If the customer did not diagnose their device correctly as ‘Needs Love’: then the customer needs to be informed of the revised terms and conditions.

If the device does not vibrate when the Mute/Vibrate Switch is flipped, this may be a result of Water Damage. Also it is mandatory to access Settings>Sounds and check if the volume button is not just turned off.
Water Damage Sensors
For iPhone 5 and up:

The sensor is on the underside of the screen and can be seen by removing the SIM Card Tray
If this sensor is red: The iPhone has been water damaged and should be classified as ‘Needs Love’.
For iPhone 4S and down: The sensors are in the Charging Port and Headphone Jack
If either sensor is red and the device works fine:

The device is considered to be fine, but if there are doubts, then the technician can remove the Rear Glass to double check the internal sensors.

If the internal sensors are white, one can proceed to the next step, however the internal sensors are red then it can be classified as under needs love condition.

### Bottom Screws

If either of the Bottom Screws are noticeably stripped or missing then it is necessary to inquire with the customer if the device has been opened or repaired before, and the Rear Glass needs to be removed for inspection if it is an iPhone 4 and 4S.

### Checking Internal Settings

Every internal spec should be thoroughly checked within the device if possible to ascertain if the device powers on the settings can be accessed. If the technician notices an anomaly that will alter the internal specifications of the device then it is required to instantly notify the customer that the offer will be revised and further the technician can proceed to edit the device within the buyback in the app to show the customer their updated offer. Also, to check the internal specs within the device, it is necessary to power on the device and make check if the device is activated and then proceed to the home screen.

The technician needs to check the carrier the phone is using and if the carrier does not match the carrier from the buyback request then it is necessary to inform the customer how it may affect their offer and then revise the buyback request within the application. The technician also needs to be sure that the device is still not active on a carrier when they check the device and in case it is a GSM device, the SIM card will remain active, but the device will not be locked to a customer's carrier account. In case it is a CDMA device then it is possible to check if the device could be still be connected to an authorized carrier's account and the technician can check this by trying to make a phone call with the device. If it is either a GSM or CDMA device and the customer has an outstanding balance then, it is understood that the device will not be available for reactivation under a new account.

### Hardware Analysis of the Phone/Client Device 104

### Capacity

If the capacity in the device does not match the capacity from the buyback request then it is necessary to inform the customer how this may affect their offer and then revise the buyback request within the application to show the revised offer.

After this step one needs to check the iPhone activation lock via iCloud as mentioned earlier in the disclosure.

### Check and Submit the IMEI/MEID/Serial Number

This step will be completed in the next phase of the Application after pictures of the device and device info have been captured. Depending on the device, the application will either ask for the IMEI, the MEID, or the serial number. Devices that do not have cellular capabilities that is which do not possess IMEI or MEID it is preferred to provide the serial number within the app. In case the device is an iPhone 4 or iPad 2 on Verizon or Sprint, then the device will have a MEID. The MEID is usually a hexadecimal that usually has 14 numbers/letters and starts with “A”. If the device does not have cellular service then it will not have an IMEI or MEID and the app will require for the serial number instead.
4 Possible IMEI Locations:
General>Settings>About
All iPhones
In a CDMA iPhone 4, it is called the MEID, and can only be found here. Dialing *#06# is the normal process for all phones.
All iPhones
SIM Card Tray
iPhone 3G, 3GS, 4 (GSM), and 4S only

If any IMEI or MEID or Serial Number is not accessible for any reason, an option will be provided to bypass this step within the iTech App. When the technician accesses this option, they will be asked to enter in a reason for not being able to use this piece of information, and then after entering the reasonable information, the app allows them to proceed.

In a preferred embodiment, a hand-holdable, portable general-purpose computer system that contains an energy storage device (for example battery is disclosed) which holds more energy than is required for the daily operation of the computing device, wireless communication abilities, and plug free charging is described. Disclosed below are the elements.

### Element 1: Portable Computer+Battery Bank

On-board electronics and software enable the computer to detect the attachment of personal portable electronic devices (ex. mobile cellular telephones), communicate with them, and provide power to either operate the devices and/or recharge their internal energy storage devices. The Electronic circuitry integrated into the computer monitors the various flows of energy to determine the direction and amount of energy transferred. The Electronic circuitry can also limit the flow of energy to levels determined safe for the attached device and estimate the time remaining to complete the recharging of the attached device's internal energy store. The computer's internal energy store is shared between the computer itself and all attached devices. Here, separate energy stores are not required. The number of attached devices is not limited and the integrated electronics can detect, schedule, and resupply the attached devices whether they are attached directly to the device or through additional interconnection hardware.

In another embodiment, if the internal energy store lacks sufficient instantaneous power transfer ability, the devices attached are scheduled by the computer to receive power in sequence. If the store lacks sufficient energy, then as much energy as possible is transferred before the computer ceases to operate.

### Element 2: Establish Authenticity, Safety, and Ownership

Communication with remote servers enables the authenticity of the connected device to be established. Information obtained via communication with the attached device is transmitted to remote servers where it is checked against manufacturer databases for known recalls, material safety notices, and defects. If an issue is known, the computer notifies the user and refuses to supply power to the attached device.

Communication with the manufacturer can determine if the device is an authentic authorized unit or an unauthorized imitation. If an imitation is detected the user is notified.

To facilitate the sale or exchange of attached devices, the computing device may communicate with the manufacturer to determine the currently registered owner of the device, check the device against lists of known stolen devices, and alert authorities in the event of a match.

Data regarding the device's energy storage abilities and safe recharging parameters is downloaded to the computer and used to configure the energy transfer hardware and regulate the flow the energy. This reduces the risk of catastrophic failure (ex. battery failure or explosion) significantly.

### Element 3: Always-Ready Plug-Free Re-Chargable Battery Bank

The computer's energy store may be recharged both by connecting it to a utility-connected power source through its power-in connector (the connector may be optionally integrated with other functions such as data transfer) or through its plug-free recharging port. This port requires no conductive contact between the recharging source and the computer.

The plug-free recharging system enables the computing device to rest on the recharging system when not in use and therefore experience a high likelihood of being near full charge when called into use. The absence of cabled connections allows the rapid connection and disconnection of charging increasing the likelihood that the user will recharge the device between short periods of use.

The computer comprises integrated electronics to safely use plug-free charging to maintain the energy store at near full charge. To do so it may periodically elect to not accept available plug-free energy when the battery is outside certain parameters (ex. too hot or too cold).

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Accordingly, the disclosure of the present invention is intended to be illustrative, but not limiting, of the scope of the invention, which is set forth in the following claims.

1. A method to evaluate the condition of hardware elements and accurately assess the price and extend of repairs, the method comprises:
extracting necessary information from a client device and subsequently evaluating the information automatically;
categorizing the client device based on the extracted information;
evaluating the price of the client device buy back condition based on the categorization;
assessing current condition of the client device; and
predicting the best buy back price for the client device in response to the assessment.

2. The method of claim 1 wherein the client device is a used computing device.

3. The method of claim 1 wherein the information extracted is related to diagnostics, serial number, and hardware information of the client device.

4. The method of claim 1 wherein the categories is one of Like New, Cracked Glass and Needs Love.

5. The method of claim 4 wherein the Like New category groups a plurality of client devices that requires a substantial amount of repair and servicing to be done.

6. The method of claim 4 wherein the Cracked Glass category groups a plurality of client devices that are normal and has a broken and damaged front glass, rear glass, LCD, and/or digitizer.

7. The method of claim 4 wherein the Needs Love category groups a plurality of client devices that requires a few repairs.

8. The method of claim 1 and further comprising:
informing the customer of the client device in case the capacity of the client device does not match the capacity from the buyback request; and
revising the buyback request to present the revised offer.

9. The method of claim 1 and further comprising:
examining accurately the physical condition of the client device.

10. The method of claim 6 wherein examining the physical condition of the client device further comprises:
checking the model number of the client device;
capturing pictures of the client device and client device information;
obtaining an IMEI or MEID or serial number of the client device; and
checking physical aspects of the device to identify even tiniest of cracks and slightest jams of buttons.

11. The method of claim 1 and further comprising:
shipping the device directly to the headquarters within a specific time period upon completion of an express sale; and
recycling the devices to prevent harmful e-waste from ending up in the landfills or any other known disposal area.

12. The method of claim 1 and further comprising:
enabling the customer to sell the client device; and
reselling the client device domestically and internationally.

13. The method of claim 1 and further comprising:
checking if the client device is part of find my phone account;
checking activation status with the servers; and
obtaining paired and unpaired device information;

14. The method of claim 13 and further comprising:
checking if the user has password protected the client device;

15. The method of claim 13 and further comprising:
retrieving battery and sensor diagnostics;

16. The method of claim 13 and further comprising:
putting the device into one of a recovery mode and DFU mode and performing device firmware upgrades.

17. A system to evaluate the condition of a client equipment and accurately assess the price and extend of repairs, the system comprises:
a client device that is a used computing device;
a network; and
a processor coupled within the client device and configured to perform:
extracting necessary information from a client device and subsequently evaluating the information automatically;
categorizing the client device based on the extracted information;
evaluating the price of the client device buy back condition based on the categorization; and
assessing current condition of the client device and predicting the best buy back price for the client device in response to the assessment.

18. The system of claim 14 wherein the client device further comprises:
a power management module to manage communication ability of the client device;
a communication module responsible to handle communication between ports and also acts as an interface between a built-in port on the processor and another communication link with a different type of protocol; and
a computing module.

19. The system of claim 14 wherein the client device further comprises:
a user interface in communication with the communication module to obtain captured images in real time and provide the captured images;
a computing module; and
a battery.

20. The system of claim 14 wherein the client device is configured with a camera to obtain images in real time.
